(19) United States
(12) Patent Application Publication
(10) Pub. No.: US 2025/0112001 A1
(43) Pub. Date: Apr. 3, 2025

(54) KEYCAP LIFTING MECHANISM AND LONG RECTANGULAR KEYSWITCH STRUCTURE

(71) Applicant: DARFON ELECTRONICS CORP., Taoyuan City (TW)

(72) Inventors: Chih-Chung Yen, Taoyuan City (TW); Po-Wei Tsai, Taoyuan City (TW); Hsun-Kun Peng, Taoyuan City (TW); Po-Min Huang, Taoyuan City (TW)

(73) Assignee: DARFON ELECTRONICS CORP., Taoyuan City (TW)

(21) Appl. No.: 18/895,392

(22) Filed: Sep. 25, 2024

Related U.S. Application Data
(60) Provisional application No. 63/540,942, filed on Sep. 28, 2023.
(60) Provisional application No. 63/643,917, filed on May 7, 2024.

(30) Foreign Application Priority Data
Sep. 20, 2024 (TW) 113135630

(51) Int. Cl. H01H 3/12; H01H 13/52

(52) U.S. Cl. CPC H01H 3/122; H01H 13/52

(57) ABSTRACT

A keycap lifting mechanism increases the stability of supporting a keycap through structure designs of supports. For example, a pivot of two supports overlaps base holes of the supports along the pivot axis. For another example, each of supports has support arms extending non-parallel to the pivot axis. The free end of each support arm is connected to a base plate. For another example, among a plurality of pivotally-connecting structures between supports, at least one includes a fully-open pivot hole, achieved by two opposite hooks, and at least one includes a semi-open pivot hole, achieved by two opposite hooks and a blind hole. A long rectangular keyswitch structure includes a keycap and any of the above mechanisms. The distance from a sliding hole of one support to an adjacent keycap long side is greater than the distance from a holder hole of another support to another adjacent keycap long side.

### CROSS REFERENCE TO RELATED APPLICATIONS

This application claims the benefit of U.S. Provisional Application No. 63/540,942, filed on Sep. 28, 2023. Further, this application claims the benefit of U.S. Provisional Application No. 63/643,917, filed on May 7, 2024. The contents of these applications are incorporated herein by reference.

### BACKGROUND OF THE INVENTION

### 1. Field of the Invention

The present invention relates to a keyswitch structure, and more particularly to a long rectangular keyswitch and a keycap lifting mechanism thereof.

### 2. Description of the Prior Art

With the miniaturization of keyswitch structures, the space available for each component is greatly reduced, and the structural strength of the components is difficult to maintain, resulting in a decrease in the stability of movement of the entire keyswitch structure. For example, the stability of the transmission between a support and another component (such as another support, a keycap or a base plate, etc.) decreases, and the stability of the support supporting the keycap also decreases. For another example, after the keyswitch structure is used for a period of time or during the assembly process of the supports, it may cause some permanent deformation of the supports, which affects the stability of movement and even renders the keyswitch structure unusable.

### SUMMARY OF THE INVENTION

In view of the problems in the prior art, an objective of the invention is to provide a keycap lifting mechanism, used for a long rectangular keyswitch. The keycap lifting mechanism utilizes the overlap of the pivot between two supports and a base hole of one support in the pivot axis direction to increase the stability of the transmission between the supports and a base plate, thereby improving the stability of movement of the entire keyswitch structure.

A keycap lifting mechanism of an embodiment according to the invention is used for a long rectangular keyswitch. The long rectangular keyswitch has a long side direction and a short side direction. The keycap lifting mechanism includes a base plate, a first support, and a second support. The base plate includes a first base hook and a second base hook. The first support includes a pivot hole, a first base shaft, and a first base hole formed beside the first base shaft. The first base shaft is rotatably hooked by the first base hook. The first base hook extends into the first base hole. The second support includes a pivot, a second base shaft, and a second base hole formed beside the second base shaft. The second base shaft is rotatably hooked by the second base hook. The second base hook extends into the second base hole. The pivot is inserted into the pivot hole so that the first support and the second support rotate relative to each other about a pivot axis. The pivot axis is parallel to the long side direction. Therein, a projection of the pivot in the long side direction overlaps a projection of the first base hook or the first base hole in the long side direction. The projection of the pivot in the long side direction overlaps a projection of the second base hook or the second base hole in the long side direction. Thereby, the moment arm from the center of the pivot hole of the first support (corresponding to the pivot axis) to the first base shaft is effectively reduced, which can increase the stability of the transmission from the pivot hole of the first support (linked by the second support) through the first base shaft to the base plate; vice versa. The same goes for the second support. This structural configuration also helps to improve the stability of the first support and the second support supporting a keycap of the long rectangular keyswitch, and also helps to suppress the occurrence of permanent deformation. Therefore, the keycap lifting mechanism can improve the stability of movement of the entire keyswitch structure.

Another objective of the invention is to provide a keycap lifting mechanism, used for a long rectangular keyswitch. Supports of the keycap lifting mechanism all have a plurality of support arms extending non-parallel to a pivot axis. The free end of each support arm is connected to a base plate. This structural design helps to improve the stability of the supporting and movement of the supports, thereby improving the stability of movement of the entire keyswitch structure.

A keycap lifting mechanism of an embodiment according to the invention is used for a long rectangular keyswitch. The long rectangular keyswitch has a long side direction and a short side direction. The keycap lifting mechanism includes a base plate, a first support, and a second support. The first support includes a first long arm and a plurality of first support arms. The first long arm extends parallel to the long side direction. The plurality of first support arms protrude from the first long arm in a direction not parallel to the long side direction and are connected to the base plate. The second support includes a second long arm and a plurality of second support arms. The second long arm extends parallel to the long side direction. The plurality of second support arms protrude from the second long arm in a direction not parallel to the long side direction and are connected to the base plate. Therein, the first support and the second support are pivotally connected around a pivot axis. One of the plurality of first support arms is located between two of the plurality of second support arms in the long side direction. One of the plurality of second support arms is located between two of the plurality of first support arms in the long side direction. Thereby, both ends of the first support arm of the first support have direct structural linkage (that is, one end is connected to the first long arm and the other end is connected to the base plate), which improves the stability of the supporting and movement of the first support. The same goes for the second support. This structural configuration also helps to improve the stability of the transmission between the first support and the second support, and also helps to suppress the occurrence of permanent deformation. Therefore, the keycap lifting mechanism can improve the stability of movement of the entire keyswitch structure.

Another objective of the invention is to provide a keycap lifting mechanism, used for a long rectangular keyswitch. The pivot structures between supports of the keycap lifting mechanism include a fully-open pivot hole and a semi-open pivot hole. This structural design helps to suppress permanent deformation that may be introduced when assembling the two supports, thereby improving the stability of movement of the entire keyswitch structure.

A keycap lifting mechanism of an embodiment according to the invention is used for a long rectangular keyswitch. The long rectangular keyswitch has a long side direction and a short side direction. The keycap lifting mechanism includes a first support and a second support. The first support includes a first semi-open pivot hole, a second semi-open pivot hole, and a fully-open pivot hole. The fully-open pivot hole is located between the first semi-open pivot hole and the second semi-open pivot hole in the long side direction. The first semi-open pivot hole includes two first hooking portions and a first blind hole. The two first hooking portions are disposed oppositely to form a first holding space. The first blind hole communicates with the first holding space. The second semi-open pivot hole includes two second hooking portions and a second blind hole. The two second hooking portions are disposed oppositely to form a second holding space. The second blind hole communicates with the second holding space. An opening of the first blind hole is opposite to an opening of the second blind hole. The fully-open pivot hole includes two third hooking portions. The two third hooking portions are disposed oppositely to form a third holding space. The second support includes a first pivot, a second pivot, and a middle pivot. The first pivot is held by the two first hooking portions in the first holding space and extends into the first blind hole. The second pivot is held by the two second hooking portions in the second holding space and extends into the second blind hole. The middle pivot is held by the two third hooking portions in the third holding space, so that the first support and the second support are pivotally connected around a pivot axis. The pivot axis is parallel to the long side direction. Thereby, when the first support and the second support are assembled together, the pivot structures (including the first semi-open pivot hole, the second semi-open pivot hole, the fully-open pivot hole, the first pivot, the second pivot, and the middle pivot) can effectively suppress permanent structural deformation, thereby improving the stability of movement of the entire keyswitch structure.

Another objective of the invention is to provide a long rectangular keyswitch, which includes one of the above keycap lifting mechanisms, which can improve the stability of movement of the entire keyswitch structure. Furthermore, in this long rectangular keyswitch, a distance from a sliding hole of one support to the long side of a keycap is greater than a distance from a holder hole of another support to the long side of the keycap, which helps to balance the supporting of the supports to the keycap, thereby improving the stability of movement of the entire keyswitch structure.

A long rectangular keyswitch of an embodiment according to the invention has a long side direction and a short side direction. The long rectangular keyswitch includes a keycap and any of the above keycap lifting mechanisms to support the keycap. The keycap has a first long side edge and a second long side edge. The first long side edge and the second long side edge are parallel to the long side direction. The keycap is supported by the first support and the second support to move up and down parallel to a vertical direction. The first support has a sliding shaft and a sliding hole formed beside the sliding shaft. The second support has a holder shaft and a holder hole formed beside the holder shaft. The first support is slidably and rotatably connected to the keycap through the sliding shaft. The second support is rotatably connected to the keycap through the holder shaft. There is a first distance in the short side direction between a projection of the sliding hole in the vertical direction and a projection of the first long side edge in the vertical direction. There is a second distance in the short side direction between a projection of the holder hole in the vertical direction and a projection of the second long side edge in the vertical direction. The first distance is greater than the second distance. Thereby, in addition to the aforementioned effects of the keycap lifting mechanism, the long rectangular keyswitch also balances the supporting of the first support and the second support to the keycap by making the distance from the sliding hole to the first long side edge greater than the distance from the holder hole to the second longest side, thereby improving the stability of movement of the entire keyswitch structure.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a partially-exploded view of a long rectangular keyswitch according to a first embodiment.

FIG. 2 is an exploded view of the long rectangular keyswitch in FIG. 1.

FIG. 3 is a top view of a first support, a second support, and a base plate of the long rectangular keyswitch in FIG. 1.

FIG. 4 is a top view of the first support in FIG. 2.

FIG. 5 is a top view of the second support in FIG. 2.

FIG. 6 is an enlarged view of a first semi-open pivot hole of the first support in FIG. 2 from another viewpoint.

FIG. 7 is an enlarged view of a second semi-open pivot hole of the first support in FIG. 2 from another viewpoint.

FIG. 8 is an enlarged view of a fully-open pivot hole circled with a chain line in the first support in FIG. 2 from another viewpoint.

FIG. 9 is an exploded view of the first support in FIG. 2.

FIG. 10 is an exploded view of the second support in FIG. 2.

FIG. 11 is a partially-exploded view of a long rectangular keyswitch according to a second embodiment.

FIG. 12 is an exploded view of the long rectangular keyswitch in FIG. 11.

FIG. 13 is a top view of a first support, a second support, and a base plate of the long rectangular keyswitch in FIG. 11.

FIG. 14 is a top view of the first support in FIG. 12.

FIG. 15 is a top view of the second support in FIG. 12.

FIG. 16 is an enlarged view of a first semi-open pivot hole of the first support in FIG. 12 from another viewpoint.

FIG. 17 is an enlarged view of a second semi-open pivot hole of the first support in FIG. 12 from another viewpoint.

FIG. 18 is an enlarged view of a fully-open pivot hole circled with a chain line in the first support in FIG. 12 from another viewpoint.

FIG. 19 is an exploded view of the first support in FIG. 12.

FIG. 20 is an exploded view of the second support in FIG. 12.

FIG. 21 is a left view of the structure shown in FIG. 13.

FIG. 22 is a partially-exploded view of a long rectangular keyswitch according to a third embodiment.

FIG. 23 is an exploded view of the long rectangular keyswitch in FIG. 22.

FIG. 24 is a top view of a first support, a second support, and a base plate of the long rectangular keyswitch in FIG. 22.

FIG. 25 is a top view of the first support in FIG. 23.

FIG. 26 is a top view of the second support in FIG. 23.

FIG. 16 is an enlarged view of a first semi-open pivot hole of

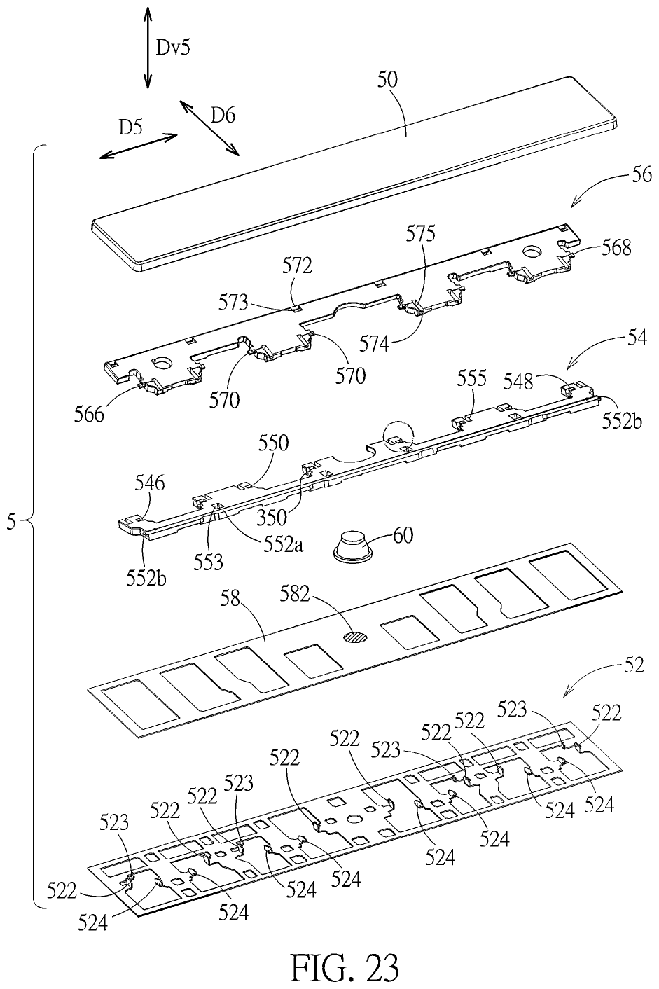

FIG. 27 is an enlarged view of a first semi-open pivot hole of the first support in FIG. 23 from another viewpoint.

FIG. 28 is an enlarged view of a second semi-open pivot hole of the first support in FIG. 23 from another viewpoint.

FIG. 29 is an enlarged view of a fully-open pivot hole circled with a chain line in the first support in FIG. 23 from another viewpoint.

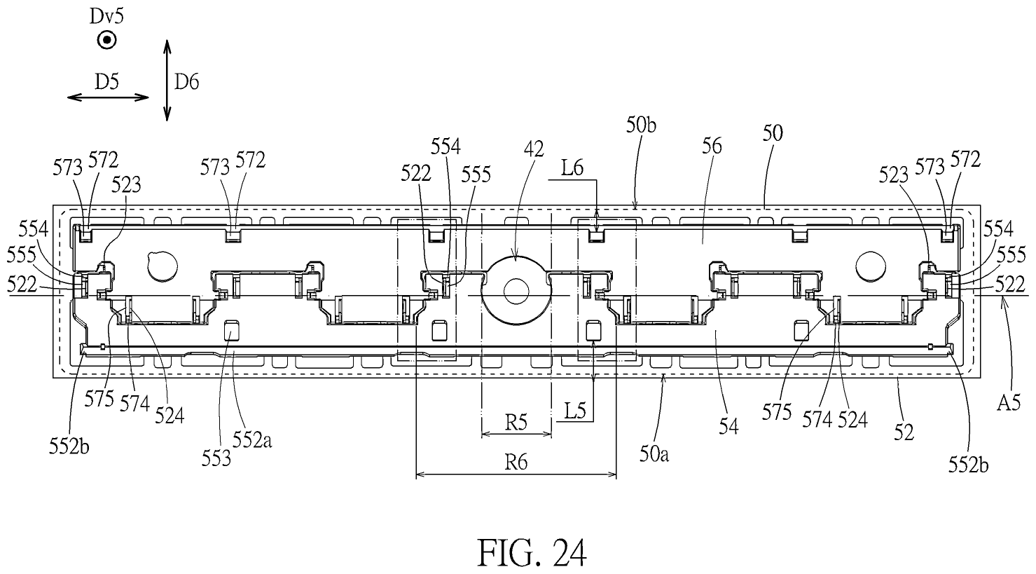

FIG. 30 is a left view of the structure shown in FIG. 24.

### DETAILED DESCRIPTION

Directional terms mentioned in the following embodiments, such as up, down, left, right, front or back, etc., are only for reference to the directions in the attached drawings. The prefixes of component names, such as first, second, . . . , etc., are only used to distinguish components and facilitate description, and do not impose other restrictions on the components themselves; furthermore, components with the same prefix in various embodiments do not necessarily correspond. The correspondence of components in each embodiment should still depend on the specific structure described in each embodiment.

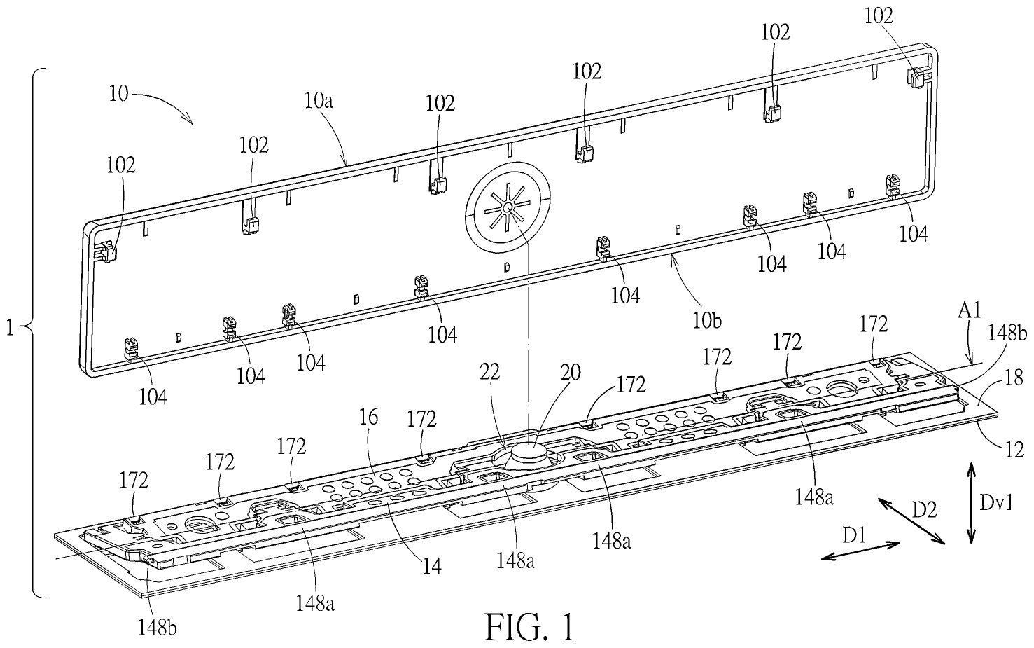

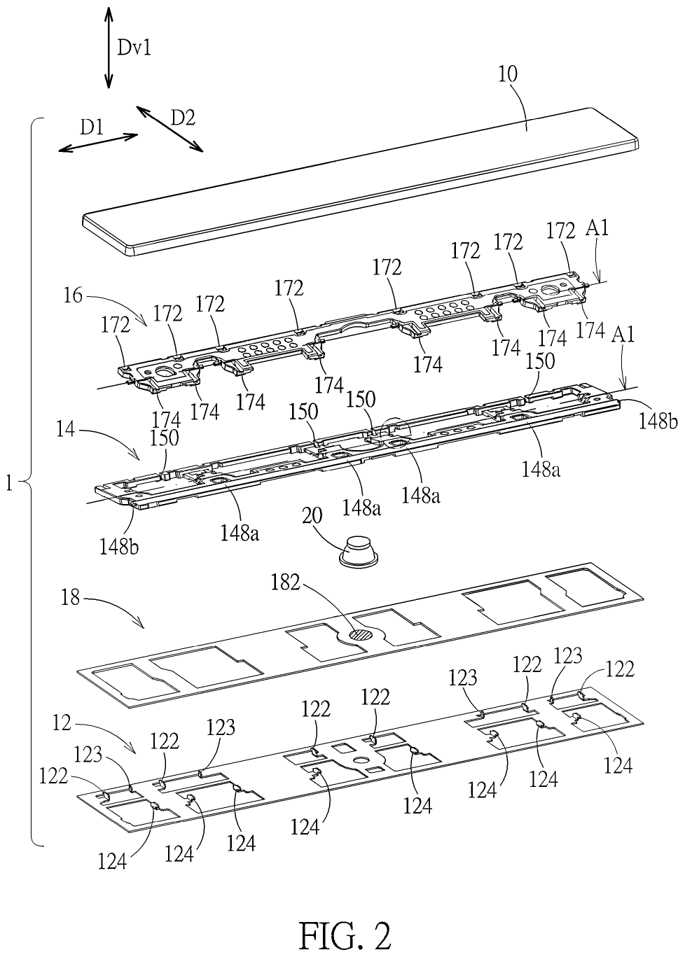

Please refer to FIG. 1 and FIG. 2. A long rectangular keyswitch 1 according to a first embodiment has a long side direction D1 and a short side direction D2 (both are indicated by double-headed arrows in the figures). The long side direction D1 is perpendicular to the short side direction D2. In practice, the long rectangular keyswitch 1 can be but is not limited to a space key. The long rectangular keyswitch 1 includes a keycap 10, a base plate 12, a first support 14, a second support 16, a switch circuit board 18, and an elastic dome 20. The keycap 10 is disposed above the base plate 12. The first support 14 and the second support 16 are pivotally connected around a pivot axis A1 (indicated by a chain line). The pivot axis A1 is parallel to the long side direction D1. The first support 14 and the second support 16 are connected to the keycap 10 and the base plate 12 to support the keycap 10 above the base plate 12, so that the keycap 10 can move (e.g. moving up and down or parallel to a vertical direction Dv1) relative to the base plate 12 through the first support 14 and the second support 16. The vertical direction Dv1 (indicated by a double-headed arrow in the figures) is perpendicular to the long side direction D1 and the short side direction D2. The switch circuit board 18 is placed on the base plate 12. The switch circuit board 18 can be but not limited to a membrane circuit board, and has a switch 182 (shown as a circle filled with oblique lines in the figure), roughly corresponding to the center of the keycap 10. The elastic dome 20 corresponds to the switch 182 and is disposed on switch circuit board 18 and below the keycap 10. The keycap 10 can be pressed to move toward the base plate 12, and then squeezes the elastic dome 20 to trigger the switch 182 downward. Therefore, in logic, the combination of the first support 14 and the second support 16 or the combination of the first support 14, the second support 16, and the base plate 12 can be regarded as a keycap lifting mechanism.

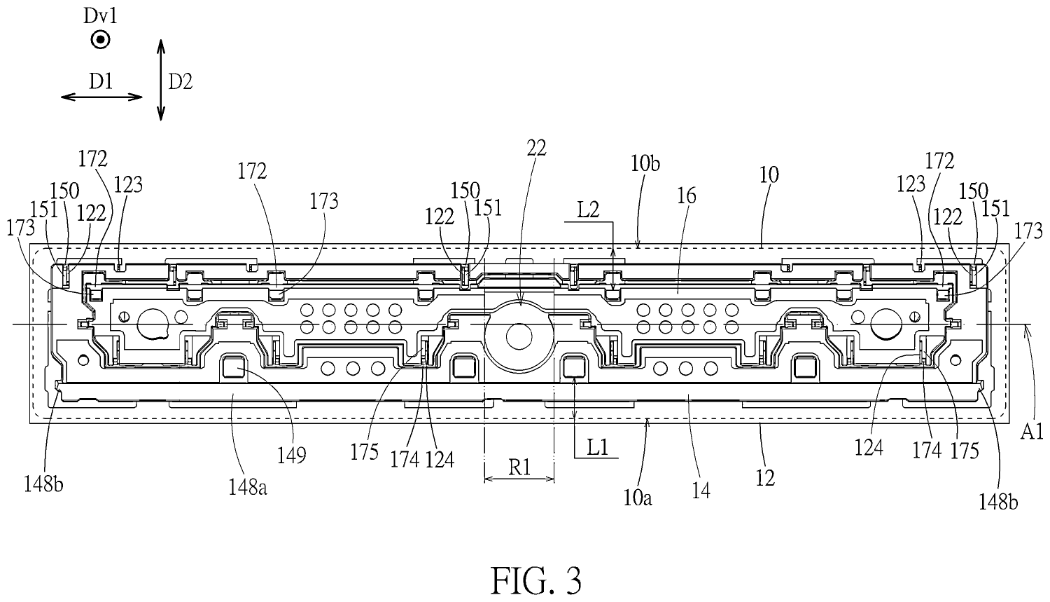

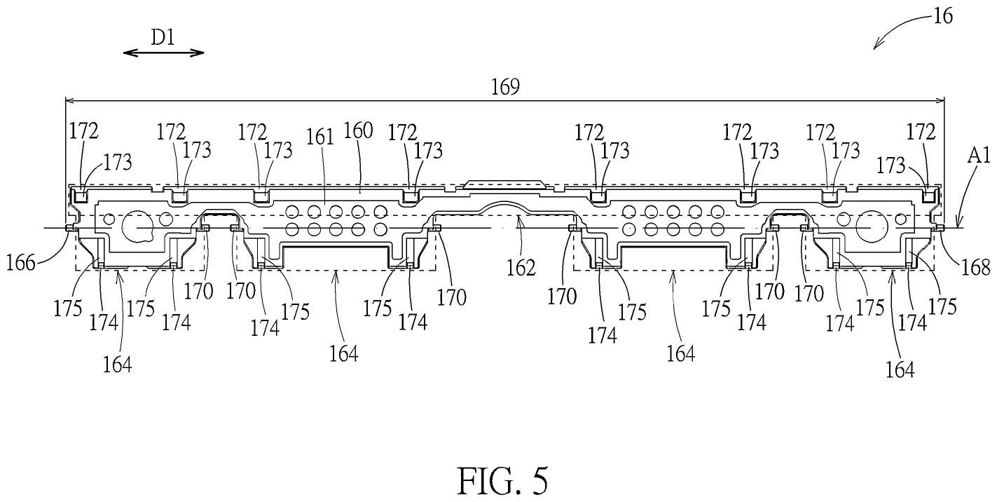

Please also refer to FIG. 3 to FIG. 5; therein, in FIG. 3, the profile of the keycap 10 is shown in dashed lines. The first support 14 as a whole shows a frame structure which mainly includes a rectangular outer frame portion and a plurality of connecting portions connecting two long sides of the rectangular outer frame portion (parallel to the long side direction D1) inside the rectangular outer frame portion. The first support 14 is connected to the keycap 10 and the base plate 12 through the two long sides of the rectangular outer frame portion. The second support 16 includes a long arm 162 and a plurality of support arms 164 which protrude from the long arm 162 in a direction not parallel to the long side direction D1 (in the first embodiment, extending perpendicular to the long side direction D1); the ranges of the long arm 162 and the support arms 164 are indicated by dashed boxes in FIG. 5. The second support 16 is connected to the keycap 10 through the long arm 162, and is connected to the base plate 12 through the support arms 164 (or ends thereof). All the ends of the support arms 164 of the second support 16 are connected to the base plate 12. The second support 16 does not have a support arm with a free end (not connected to the base plate 12), so all the support arms 164 of the second support 16 substantially contribute to the whole structural strength of the second support 16. The second support 16 is pivotally connected to the inside of the first support 14; on the other hand, the first support 14 is located on the two opposite outer sides of the second support 16 on the pivot axis A1. In logic, the first support 14 can be regarded as an outer support, and the second support 16 can be regarded as an inner support.

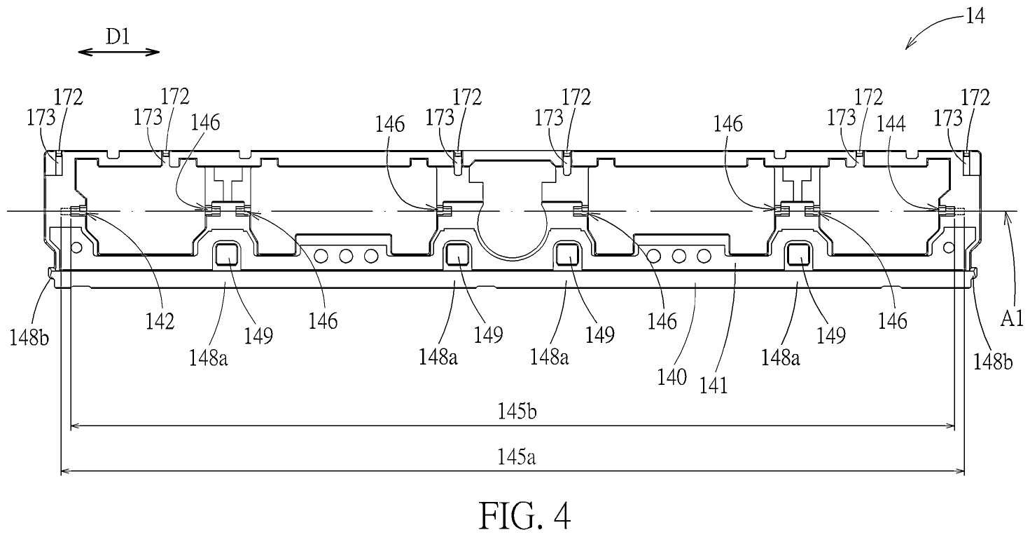

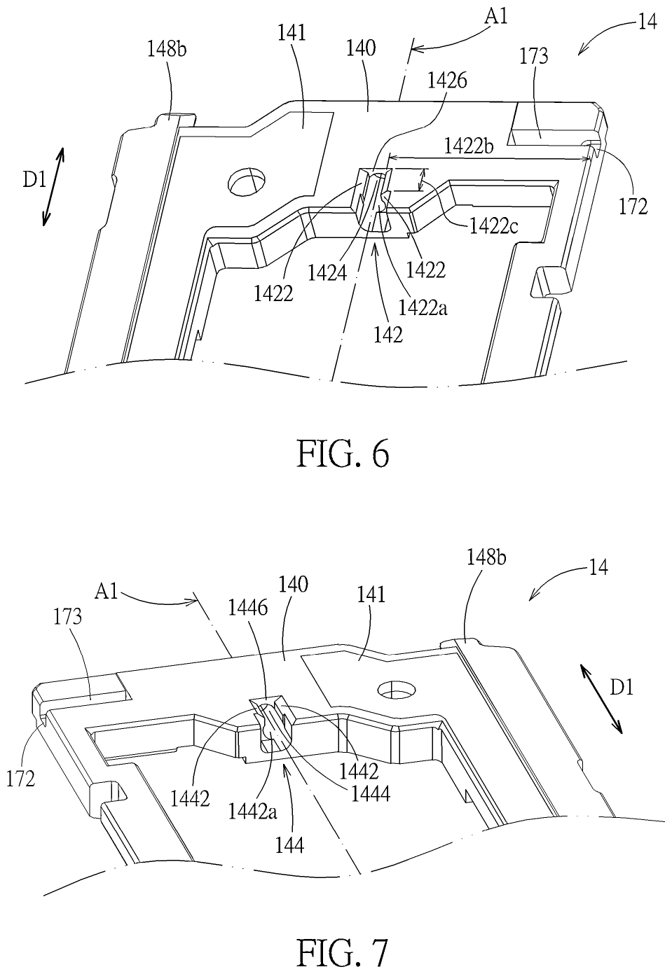

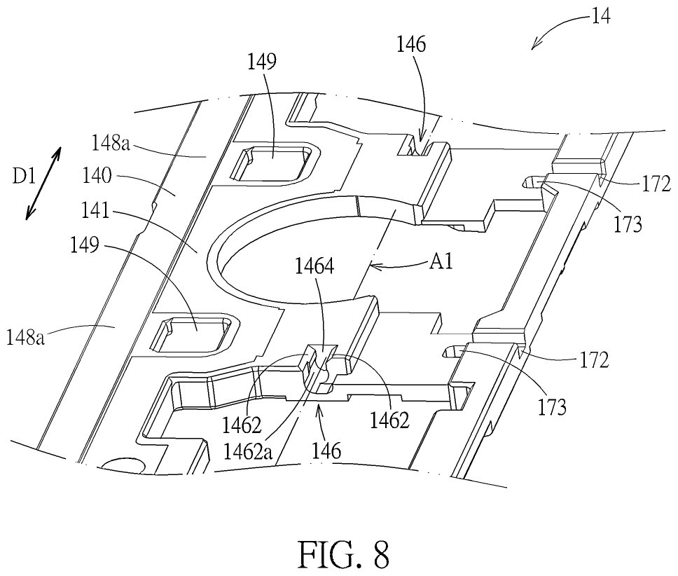

As shown by FIG. 4, the first support 14 includes a first semi-open pivot hole 142, a second semi-open pivot hole 144, and six fully-open pivot holes 146. The six fully-open pivot holes 146 are arranged between the first semi-open pivot hole 142 and the second semi-open pivot hole 144 on the pivot axis A1. Please also refer to FIG. 6. The first semi-open pivot hole 142 includes two first hooking portions 1422 and a first blind hole 1424, which are adjacently arranged along the pivot axis A1. The two first hooking portions 1422 are arranged opposite to form a first holding space 1422a. The first holding space 1422a communicates with the first blind hole 1424. Please refer to FIG. 4 and FIG. 7. The second semi-open pivot hole 144 includes two second hooking portions 1442 and a second blind hole 1444, which are adjacently arranged along the pivot axis A1. The two second hooking portion 1442 are arranged opposite to form a second holding space 1442a. The second holding space 1442a communicates with the second blind hole 1444. As shown by FIG. 4, the first semi-open pivot hole 142 and the second semi-open pivot hole 144 are structurally symmetrical. Please refer to FIG. 4 and FIG. 8; FIG. 8 is an enlarged view of one of the fully-open pivot holes 146. The fully-open pivot hole 146 includes two third hooking portions 1462. The two third hooking portions 1462 are arranged opposite to form a third holding space 1462a. The structures of the other fully-open pivot holes 146 are also the same, but the orientations may be the same or opposite (which can be determined based on FIG. 4), which will not be described in addition.

In addition, as shown by FIG. 6, a distance 1422b from the front end of the first hooking portion 1422 that is closer to a base plate connection side edge of the first support 14 (i.e., closer to a side edge of the base plate 12) than the other first hooking portion 1422 to the base plate connection side edge in the short side direction D2 is greater than a width 1422c of the first hooking portion 1422 in the long side direction D1. For example, the distance 1422b is 1 to 4 times of the width 1422c, but it is not limited thereto in practice. This structural design helps to maintain the structural strength of the first hooking portion 1422 and the holding force of the two first hooking portions 1422.

As shown by FIG. 5, the second support 16 includes a first pivot 166, a second pivot 168, and six middle pivots 170. The six middle pivots 170 are arranged between the first pivot 166 and the second pivot 168 on the pivot axis A1. Please also refer to FIG. 3. By the first pivot 166, the second pivot 168, and the six middle pivots 170 engaged with the first semi-open pivot hole 142, the second semi-open pivot hole 144, and the six fully-open pivot holes 146 respectively, the first support 14 and the second support 16 are pivotally connected around the pivot axis A1. Therein, as shown by FIG. 3, the first pivot 166 is held by the two first hooking portions 1422 in the first holding space 1422a and extends into the first blind hole 1424. The second pivot 168 is held by the two second hooking portions 1442 in the second holding space 1442a and extends into the second blind hole 1444. The middle pivot 170 is held by the two third hooking portions 1462 in the third holding space 1462a. Therein, in the first semi-open pivot hole 142, the first pivot 166 is structurally constrained by the two first hooking portions 1422 and the first blind hole 1424 at the same time; the same goes for the second semi-open pivot hole 144 and the second pivot 168. In the fully-open pivot hole 146, the middle pivot 170 is mainly structurally constrained by the two third hooking portions 1462. Therefore, in principle, the connection strength between the first semi-open pivot hole 142 and the first pivot 166 (or between the second semi-open pivot hole 144 and the second pivot 168) is greater than the connection strength between the fully-open pivot hole 146 and the middle pivot 170.

Please refer to FIG. 3 to FIG. 5. In the first support 14, there is a distance 145a between the bottom of the first blind hole 1424 (of the first semi-open pivot hole 142) and the bottom of the second blind hole 1444 (of the second semi-open pivot hole 144) along the pivot axis A1. There is a distance 145b between the opening of the first blind hole 1424 and the opening of the second blind hole 1444 along the pivot axis A1. Therein, the hidden profiles of the first blind hole 1424 and the second blind hole 1444 in FIG. 4 are shown in dashed lines. In the second support 16, there is a distance 169 between the end of the first pivot 166 and the end of the second pivot 168 along pivot axis A1. The distance 169 is greater than the distance 145b and less than the distance 145a. In an actual assembly of the first support 14 and the second support 16, force can be applied to the second support 16 first to make it slightly arched, so that the linear distance between the first pivot 166 and the second pivot 168 is reduced to be less than the linear distance between the first semi-open pivot hole 142 and the second semi-open pivot hole 144. Then, keep the second support 16 arched and snap the first pivot 166 and second pivot 168 of the second support 16 into the first semi-open pivot hole 142 and the second semi-open pivot hole 144; then, release the second support 16. At this time, the middle pivots 170 will contact the corresponding fully-open pivot holes 146 in principle. Then, press the second support 16 toward the first support 14 to make the middle pivots 170 snap into the fully-open pivot holes 146. Finally, the first semi-open pivot hole 142, the second semi-open pivot hole 144, and the fully-open pivot hole 146 are completely engaged to the first pivot 166, the second pivot 168, and the middle pivot 170 respectively. In addition, in the connection structure of the first support 14 and the second support 16, the first semi-open pivot hole 142 and the second semi-open pivot hole 144 are located at the outermost side of the first support 14 along the pivot axis A1, so in the process of assembling the first support 14 and the second support 16, the second support 16 can make the first pivot 166 and the second pivot 168 to connect with the first semi-open pivot hole 142 and the second semi-open pivot hole 144 with a small degree of deformation. In other words, this connection structure design can take into account the ease of assembly of the first support 14 and the second support 16 and the overall connection strength between the first support 14 and the second support 16. Furthermore, that the first semi-open pivot hole 142 and the second semi-open pivot hole 144 are located at the outermost side along the pivot axis A1 also helps to maintain the stability of the pivot connection between the first support 14 and the second support 16.

In addition, as shown by FIG. 6 to FIG. 8, in the first embodiment, the two first hooking portions 1422, the two second hooking portions 1442, or the two third hooking portions 1462 have, along the pivot axis A1, an open structure on one side and a side wall on the other side (therein, the side wall extends perpendicular to the pivot axis A1 and connects the two hooking portions; e.g., the side wall 1426 in FIG. 6, the side wall 1446 in FIG. 7, and the side wall 1464 in FIG. 8). This structural design helps to increase the structural strength of the hooking portions themselves and the holding strength of the hooking portions. However, it is not limited thereto in practice. For example, it is practicable to modify the structures of the two first hooking portions 1422, the second hooking portions 1442, or the two third hooking portions 1462 so that their structures are open on both sides along the pivot axis A1 (that is, there is no side wall to connect them); this structural design can increasing its structural flexibility, which is conducive to the assembly of the first pivot 166, the second pivot 168, and the middle pivots 170.

Please refer to FIG. 1 to FIG. 4. The first support 14 has six sliding shafts 148a and 148b and six base shafts 150. The six sliding shafts 148a and 148b are arranged parallel to the pivot axis A1; therein, the four sliding shafts 148a are located between the two sliding shafts 148b. The sliding shaft 148b is achieved by a protruding post extending parallel to the pivot axis A1. The first support 14 also has a sliding hole 149 formed beside each sliding shaft 148a. The first support 14 is slidably and rotatably connected to the keycap 10 (or the sliding hooks 102 thereof) through the sliding shafts 148a and 148b; therein, the sliding hooks 102 extend into the corresponding sliding holes 149. Furthermore, the six base shafts 150 are arranged parallel to the pivot axis A1. The first support 14 also has a base hole 151 formed beside each base shaft 150. The first support 14 is rotatably connected to the base plate 12 (or the base hooks 122 thereof) through the base shafts 150; therein, the base shafts 150 are rotatably hooked by the corresponding base hooks 122, and the base hooks 122 extend into the corresponding base holes 151. Furthermore, the base plate 12 also includes a plurality of stop portions 123. The stop portions 123 limit the first support 14 so that the base shafts 150 remain hooked by the corresponding base hooks 122.

Please refer to FIG. 1 to FIG. 3 and FIG. 5. The second support 16 has eight holder shafts 172 and eight base shafts 174. The eight holder shafts 172 and the eight base shafts 174 are arranged parallel to the pivot axis A1. The eight holder shafts 172 are disposed on the long arm 162. Each support arm 164 is provided with two base shafts 174. The second support 16 also has a holder hole 173 formed beside each holder shaft 172. The second support 16 is rotatably connected to the keycap 10 (or the holder hooks 104 thereof) through the holder shafts 172; therein, the holder hooks 104 extends into the corresponding holder holes 173. Furthermore, the second support 16 also has a base hole 175 formed beside each base shaft 174. The second support 16 is slidably and rotatably connected to the base plate 12 (or the base hooks 124 thereof) through the base shafts 174; therein, the base shafts 174 are slidably and rotatably hooked by the corresponding base hook 124, and the base hooks 124 extend into the corresponding base holes 175.

Furthermore, please refer to FIG. 1 and FIG. 3. The keycap 10 has a first long side edge 10a and a second long side edge 10b. The first long side edge 10a and the second long side edge 10b both are parallel to the long side direction D1. In FIG. 3, the vertical direction Dv1 is perpendicular to the paper, so the structural profiles presented in the figure are equivalent to their vertical projections on the paper; furthermore, the profile of the keycap 10 is shown in dashed lines in FIG. 3. In the first embodiment, there is a first distance L1 in the short side direction D2 between a projection of the sliding hole 149 of the first support 14 in the vertical direction Dv1 and a projection of the first long side edge 10a of the keycap 10 in the vertical direction Dv1. There is a second distance L2 in the short side direction D2 between a projection of the holder hole 173 of the second support 16 in the vertical direction Dv1 and a projection of the second long side edge 10b of the keycap 10 in the vertical direction Dv1. The first distance L1 is greater than the second distance L2. This structural configuration provides a larger space for the design of the structural and movement of the sliding shafts 148a of the first support 14. Furthermore, a shaft diameter of the sliding shaft 148a of the first support 14 is greater than a shaft diameter of the holder shaft 172 of the second support 16; this structural configuration helps to increase the rotation and sliding stability of the sliding shafts 148a.

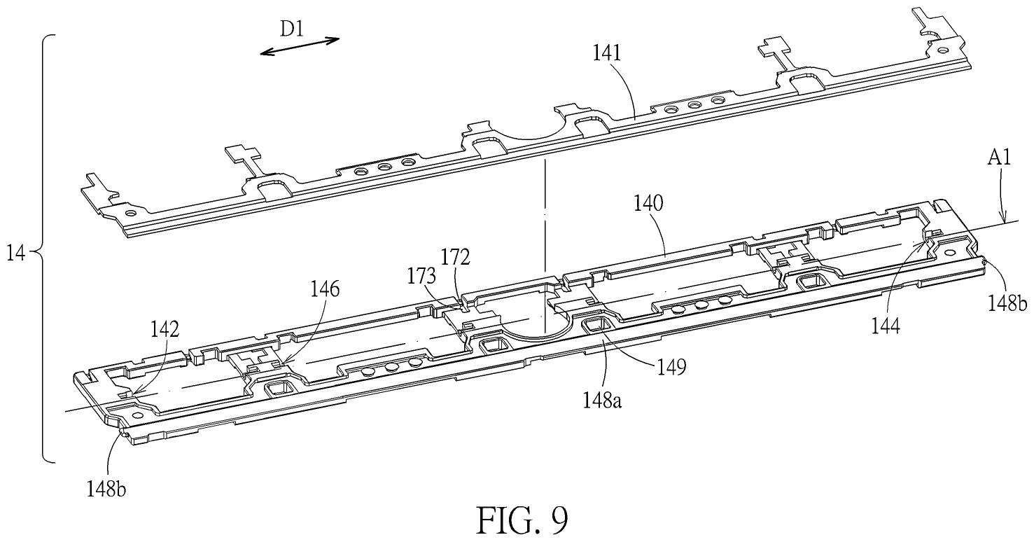

In addition, in the first embodiment, the first support 14 and the second support 16 both have structurally reinforced designs. Please refer to FIG. 4 and FIG. 9; therein, FIG. 9 is an exploded view of the first support 14. The first support 14 includes a support body 140 and a reinforcement part 141. The reinforcement part 141 is embedded into the support body 140. The reinforcement part 141 goes through the sliding shaft 148a and completely surrounds the sliding hole 149. Both structural features can increase the structural strength of the sliding shaft 148a, thereby contributing to the rotation and sliding stability of the sliding shaft 148a. Furthermore, the reinforcement part 141 are provided to also partially surround the first semi-open pivot hole 142 and the second semi-open pivot hole 144 (around three sides of each pivot hole), which helps to increase the structural strength of the first semi-open pivot hole 142 and the second semi-open pivot hole 144, thereby conducive to the stability of the pivot connection between the first support 14 and the second support 16. In addition, the reinforcement part 141 itself also has a plurality of bending structures extending parallel to the pivot axis A1. This structural feature helps to increase the structural strength of the reinforcement part 141 itself, thereby increasing the structural strength of the first support 14. Furthermore, in the first embodiment, although the reinforcement part 141 is not distributed over the entire rectangular outer frame portion of the first support 14 (for example, the reinforcement part 141 exists on the two short sides and one of the two long sides of the rectangular outer frame portion), the reinforcement part 141 still has a structure connecting the two long sides of the rectangular outer frame (by going through a connection portion inside the rectangular outer frame portion that connecting two sides of the rectangular outer frame portion), so that the reinforcement part 141 can still have a certain structural strengthening effect on the entire rectangular outer frame portion. In practice, the reinforcement part 141 can also be designed to exist on the both long sides at the same time.

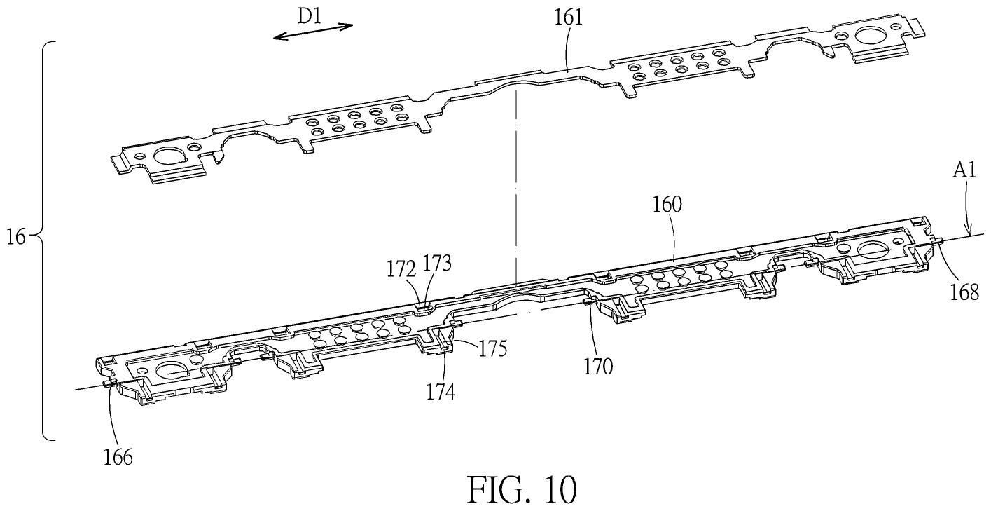

Similarly, please refer to FIG. 5 and FIG. 10; therein, FIG. 10 is an exploded view of the second support 16. The second support 16 includes a support body 160 and a reinforcement part 161. The reinforcement part 161 is embedded into the support body 160 to strengthen the structural strength of the second support 16. Furthermore, the reinforcement part 161 itself also has a plurality of bending structures, which helps to increase the structural strength of the reinforcement part 161 itself, thereby increasing the structural strength of the second support 16. In addition, in practice, the support bodies 140 and 160 may be made of, but are not limited to, plastic, and the reinforcement parts 141 and 161 may be made of, but are not limited to, metal. Furthermore, it is not limited to the fact in practice that both the first support 14 and the second support 16 are structurally reinforced through the reinforcement parts 141 and 161.

In addition, as shown by FIG. 3, in the first embodiment, the first support 14 and the second support 16 jointly form a dome hole 22 (in which the elastic dome 20 is accommodated, as shown by FIG. 1). For the first support 14 and the second support 16, a dome hole coverage range R1 (whose range is marked with chain lines in the figure) is defined in the long side direction D1 with the dome hole 22 as boundaries. The first support 14 and the second support 16 do not have a structure (e.g., like the sliding shaft 148a/the sliding hole 149, the holder shaft 172/the holder hole 173) connected to the keycap 10 and the base plate 12 within the dome hole coverage range R1. This structural design can prevent the structure of the first support 14 and the second support 16 from being weakened by the connection structure.

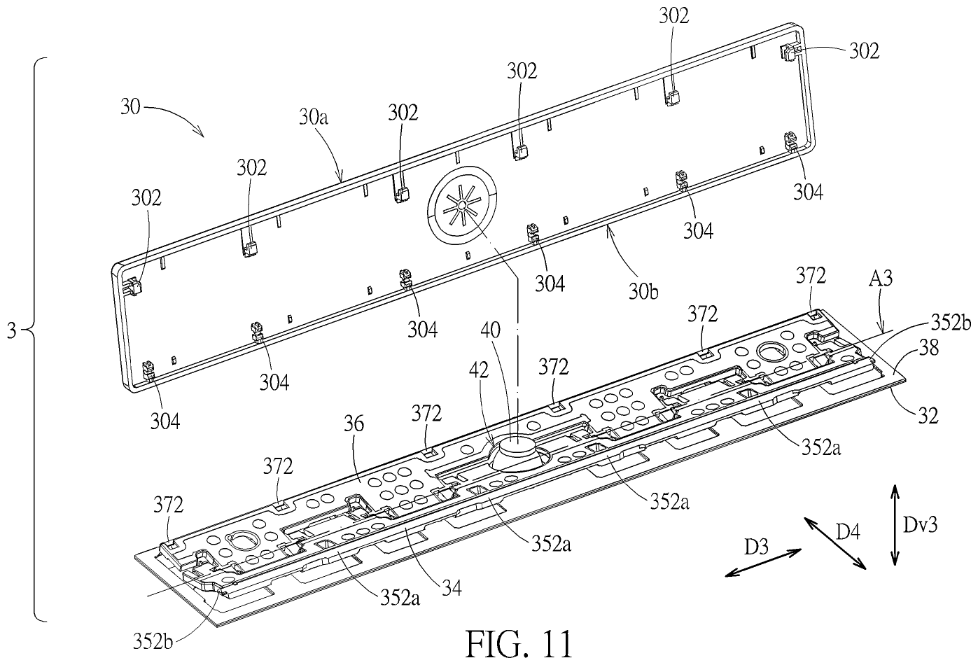

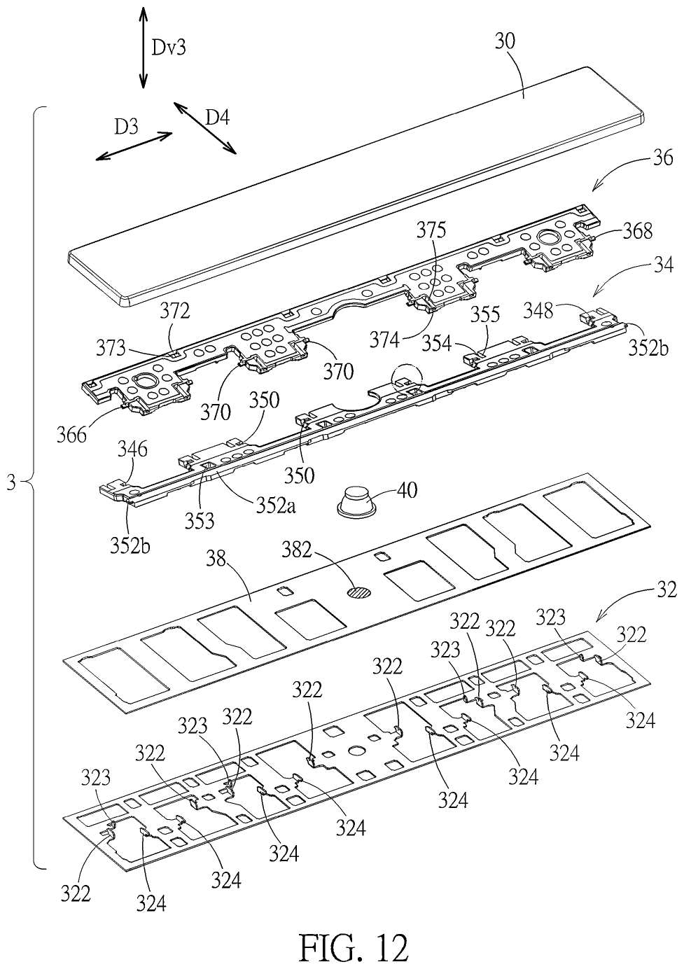

Please refer to FIG. 11 and FIG. 12. A long rectangular keyswitch 3 according to a second embodiment has a long side direction D3 and a short side direction D4 (both are indicated by double-headed arrows in the figures). The long side direction D3 is perpendicular to the short side direction D4. In practice, the long rectangular keyswitch 3 can be but is not limited to a space key. The long rectangular keyswitch 3 includes a keycap 30, a base plate 32, a first support 34, a second support 36, a switch circuit board 38, and an elastic dome 40. The keycap 30 is disposed above the base plate 32. The first support 34 and the second support 36 are pivotally connected around a pivot axis A3 (indicated by a chain line). The pivot axis A3 is parallel to the long side direction D3. The first support 34 and the second support 36 are connected to the keycap 30 and the base plate 32 to support the keycap 30 above the base plate 32, so that the keycap 30 can move (e.g. moving up and down or parallel to a vertical direction Dv3) relative to the base plate 32 through the first support 34 and the second support 36. The vertical direction Dv3 (indicated by a double-headed arrow in the figures) is perpendicular to the long side direction D3 and the short side direction D4. The switch circuit board 38 is placed on the base plate 32. The switch circuit board 38 can be but not limited to a membrane circuit board, and has a switch 382 (shown as a circle filled with oblique lines in the figure), roughly corresponding to the center of the keycap 30. The elastic dome 40 corresponds to the switch 382 and is disposed on switch circuit board 38 and below the keycap 30. The keycap 30 can be pressed to move toward the base plate 32, and then squeezes the elastic dome 40 to trigger the switch 382 downward. Therefore, in logic, the combination of the first support 34 and the second support 36 or the combination of the first support 34, the second support 36, and the base plate 32 can be regarded as a keycap lifting mechanism.

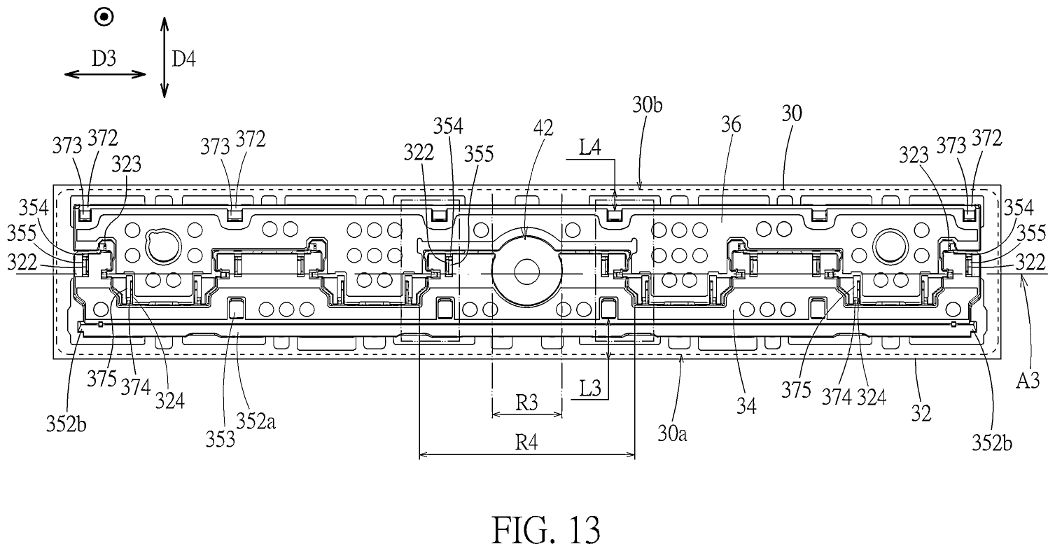

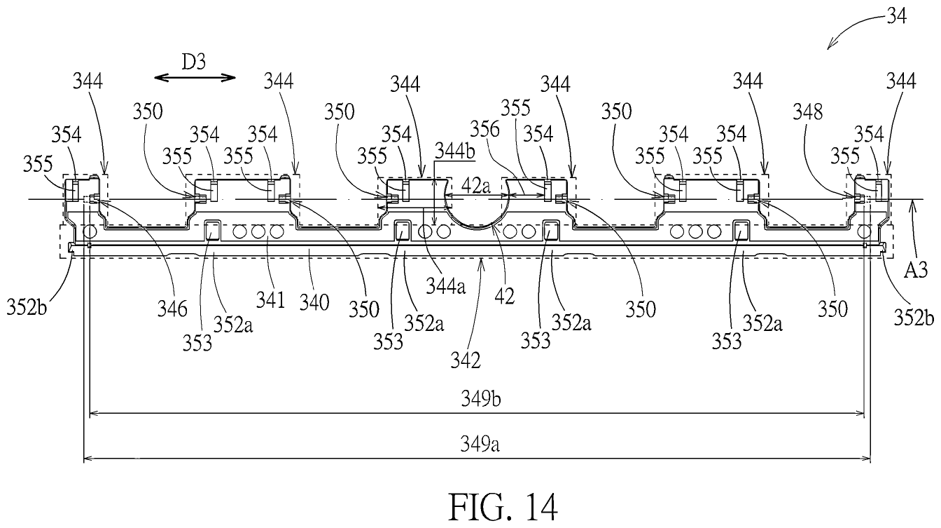

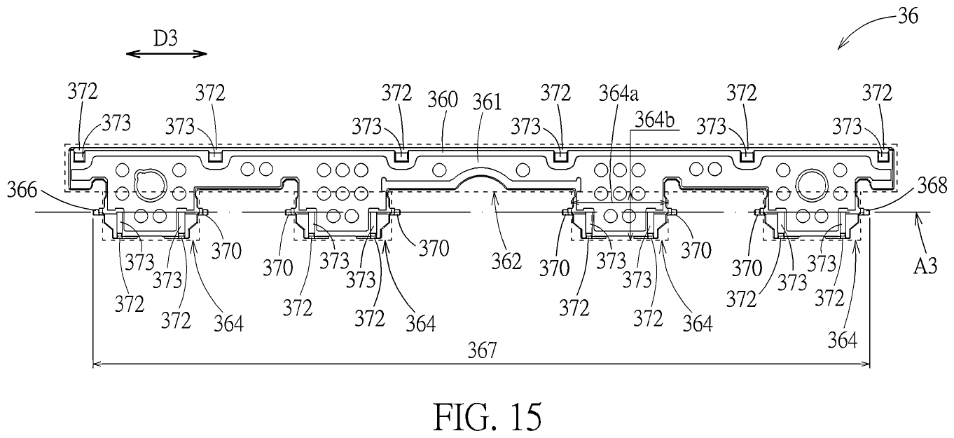

Please also refer to FIG. 13 to FIG. 15; therein, in FIG. 13, the profile of the keycap 30 is shown in dashed lines. The first support 34 includes a first long arm 342 and a plurality of first support arms 344 which protrude from the first long arm 342 in a direction not parallel to the long side direction D3 (in the second embodiment, extending perpendicular to the long side direction D3); the ranges of the first long arm 342 and the support arms 344 are indicated by dashed boxes in FIG. 14. The first support 34 is connected to the keycap 30 through the first long arm 342, and is connected to the base plate 32 through the first support arms 344 (or ends thereof). The second support 36 includes a second long arm 362 and a plurality of second support arms 364 which protrude from the second long arm 362 in a direction not parallel to the long side direction D3 (in the second embodiment, extending perpendicular to the long side direction D3); the ranges of the second long arm 362 and the second support arms 364 are indicated by dashed boxes in FIG. 15. The second support 36 is connected to the keycap 30 through the second long arm 362, and is connected to the base plate 32 through the second support arms 364 (or ends thereof). The first support 34 and the second support 36 are pivotally connected through the plurality of first support arms 344 and the plurality of second support arms 364. The plurality of first support arms 344 and the plurality of second support arms 364 are roughly staggered along the pivot axis A3. Therein, the outermost support arms on the pivot axis A3 are the first support arms 344; at least, one of the first support arms 344 is located between two of the second support arms 364 in the long side direction D3, and one of the second support arms 364 is located between two of the first support arms 344 in the long side direction D3. On the other hand, the first support 34 extends to two opposite outer sides of the second support 36 on the pivot axis A3. In logic, the first support 34 can be regarded as an outer support, and the second support 36 can be regarded as an inner support. Furthermore, all the ends of the first support arms 344 of the first support 34 are connected to the base plate 32. The first support 34 does not have a support arm with a free end (not connected to the base plate 32), so all the first support arms 344 of the first support 34 substantially contribute to the whole structural strength of the first support 34. Similarly, all the ends of the second support arms 364 of the second support 36 are connected to the base plate 32. The second support 36 does not have a support arm with a free end (not connected to the base plate 32), so all the second support arms 364 of the second support 36 substantially contribute to the whole structural strength of the second support 36. This structural configuration can increase the stability of movement of the first support 34 and second support 36.

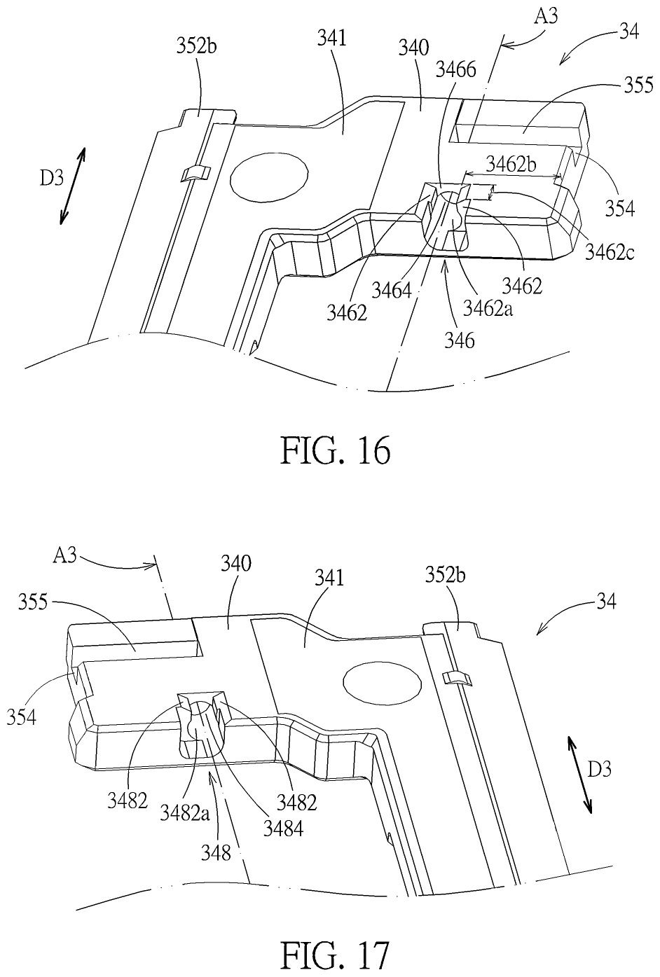

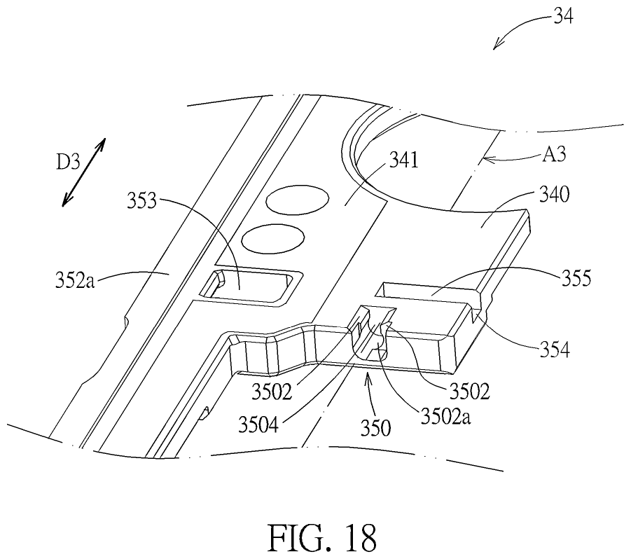

As shown by FIG. 14, the first support 34 includes a first semi-open pivot hole 346, a second semi-open pivot hole 348, and six fully-open pivot holes 350, which are disposed on the plurality of first support arms 344. The six fully-open pivot holes 350 are arranged between the first semi-open pivot hole 346 and the second semi-open pivot hole 348 on the pivot axis A3. Please also refer to FIG. 16. The first semi-open pivot hole 346 includes two first hooking portions 3462 and a first blind hole 3464, which are adjacently arranged along the pivot axis A3. The two first hooking portions 3462 are arranged opposite to form a first holding space 3462a. The first holding space 3462a communicates with the first blind hole 3464. Please refer to FIG. 14 and FIG. 17. The second semi-open pivot hole 348 includes two second hooking portions 3482 and a second blind hole 3484, which are adjacently arranged along the pivot axis A3. The two second hooking portion 3482 are arranged opposite to form a second holding space 3482a. The second holding space 3482a communicates with the second blind hole 3484. As shown by FIG. 14, the first semi-open pivot hole 346 and the second semi-open pivot hole 348 are structurally symmetrical. Please refer to FIG. 14 and FIG. 18; FIG. 18 is an enlarged view of one of the fully-open pivot holes 350. The fully-open pivot hole 350 includes two third hooking portions 3502. The two third hooking portions 3502 are arranged opposite to form a third holding space 3502a. The structures of the other fully-open pivot holes 350 are also the same, but the orientations may be the same or opposite (which can be determined based on FIG. 14), which will not be described in addition.

In addition, as shown by FIG. 16, a distance 3462b from the front end of the first hooking portion 3462 that is closer to a base plate connection side edge of the first support 34 (i.e. closer to a side edge of the base plate 32) than the other first hooking portion 3462 to the base plate connection side edge in the short side direction D4 is greater than a width 3462c of the first hooking portion 3462 in the long side direction D3. For example, the distance 3462b is 1 to 4 times of the width 3462c, but it is not limited thereto in practice. This structural design helps to maintain the structural strength of the first hooking portion 3462 and the holding force of the two first hooking portions 3462.

As shown by FIG. 15, the second support 36 includes a first pivot 366, a second pivot 368, and six middle pivots 370. The six middle pivots 370 are arranged between the first pivot 366 and the second pivot 368 on the pivot axis A3. Please also refer to FIG. 13. By the first pivot 366, the second pivot 368, and the six middle pivots 370 engaging with the first semi-open pivot hole 346, the second semi-open pivot hole 348, and the six fully-open pivot holes 350 respectively, the first support 34 and the second support 36 are pivotally connected around the pivot axis A3. Therein, as shown by FIG. 13, the first pivot 366 is held by the two first hooking portions 3462 in the first holding space 3462a and extends into the first blind hole 3464. The second pivot 368 is held by the two second hooking portions 3482 in the second holding space 3482a and extends into the second blind hole 3484. The middle pivot 370 is held by the two third hooking portions 3502 in the third holding space 3502a. Therein, in the first semi-open pivot hole 346, the first pivot 366 is structurally constrained by the two first hooking portions 3462 and the first blind hole 3464 at the same time; the same goes for the second semi-open pivot hole 348 and the second pivot 368. In the fully-open pivot hole 350, the middle pivot 370 is mainly structurally constrained by the two third hooking portions 3502. Therefore, in principle, the connection strength between the first semi-open pivot hole 346 and the first pivot 366 (or between the second semi-open pivot hole 348 and the second pivot 368) is greater than the connection strength between the fully-open pivot hole 350 and the middle pivot 370.

Please refer to FIG. 13 to FIG. 15. In the first support 34, there is a distance 349a between the bottom of the first blind hole 3464 (of the first semi-open pivot hole 346) and the bottom of the second blind hole 3484 (of the second semi-open pivot hole 348) along the pivot axis A3. There is a distance 349b between the opening of the first blind hole 3464 and the opening of the second blind hole 3484 along the pivot axis A3. Therein, the hidden profiles of the first blind hole 3464 and the second blind hole 3484 in FIG. 14 are shown in dashed lines. In the second support 36, there is a distance 367 between the end of the first pivot 366 and the end of the second pivot 368 along pivot axis A3. The distance 367 is greater than the distance 349b and less than the distance 349a. In an actual assembly of the first support 34 and the second support 36, force can be applied to the second support 36 first to make it slightly arched, so that the linear distance between the first pivot 366 and the second pivot 368 is reduced to be less than the linear distance between the first semi-open pivot hole 346 and the second semi-open pivot hole 348. Then, keep the second support 36 arched and snap the first pivot 366 and second pivot 368 of the second support 36 into the first semi-open pivot hole 346 and the second semi-open pivot hole 348; then, release the second support 36. At this time, the middle pivots 370 will contact the corresponding fully-open pivot holes 350 in principle. Then, press the second support 36 toward the first support 34 to make the middle pivots 370 snap into the fully-open pivot holes 350. Finally, the first semi-open pivot hole 346, the second semi-open pivot hole 348, and the fully-open pivot hole 350 are completely engaged to the first pivot 366, the second pivot 368, and the middle pivot 370 respectively. In addition, in the connection structure of the first support 34 and the second support 36, the first semi-open pivot hole 346 and the second semi-open pivot hole 348 are located at the outermost side of the first support 34 along the pivot axis A3, so in the process of assembling the first support 34 and the second support 36, the second support 36 can make the first pivot 366 and the second pivot 368 to connect with the first semi-open pivot hole 346 and the second semi-open pivot hole 348 with a small degree of deformation. In other words, this connection structure design can take into account the ease of assembly of the first support 34 and the second support 36 and the overall connection strength between the first support 34 and the second support 36. Furthermore, that the first semi-open pivot hole 346 and the second semi-open pivot hole 348 are located at the outermost side along the pivot axis A3 also helps to maintain the stability of the pivot connection between the first support 34 and the second support 36.

In addition, as shown by FIG. 16 to FIG. 18, in the second embodiment, the two first hooking portions 3462, the two second hooking portions 3482, or the two third hooking portions 3502 have, along the pivot axis A3, an open structure on one side and a side wall on the other side (therein, the side wall extends perpendicular to the pivot axis A3 and connects the two hooking portions; e.g., the side wall 3466 in FIG. 16, the side wall 3486 in FIG. 17, and the side wall 3504 in FIG. 18). This structural design helps to increase the structural strength of the hooking portions themselves and the holding strength of the hooking portions. However, it is not limited thereto in practice. For example, it is practicable to modify the structures of the two first hooking portions 3462, the second hooking portions 3482, or the two third hooking portions 3502 so that their structures are open on both sides along the pivot axis A3 (that is, there is no side wall to connect them); this structural design can increasing its structural flexibility, which is conducive to the assembly of the first pivot 366, the second pivot 368, and the middle pivots 370.

Please refer to FIG. 11 to FIG. 14. The first support 34 has six sliding shafts 352a and 352b and eight base shafts 354. The six sliding shafts 352a and 352b are arranged parallel to the pivot axis A3 on the first long arm 342; therein, the four sliding shafts 352a are located between the two sliding shafts 352b. The sliding shaft 352b is achieved by a protruding post extending parallel to the pivot axis A3. The first support 34 also has a sliding hole 353 formed beside each sliding shaft 352a. The first support 34 is slidably and rotatably connected to the keycap 30 (or the sliding hooks 102 thereof) through the sliding shafts 352a and 352b; therein, the sliding hooks 302 extend into the corresponding sliding holes 353. Furthermore, the eight base shafts 354 are arranged parallel to the pivot axis A3 on the plurality of first support arms 344. The first support 34 also has a base hole 355 formed beside each base shaft 354. The first support 34 is rotatably connected to the base plate 32 (or the base hooks 322 thereof) through the base shafts 354; therein, the base shafts 354 are rotatably hooked by the corresponding base hooks 322, and the base hooks 322 extend into the corresponding base holes 355. Furthermore, the base plate 32 also includes a plurality of stop portions 323. The stop portions 323 limit the first support 34 so that the base shafts 354 remain hooked by the corresponding base hooks 322. In addition, in the second embodiment, the stop portion 323 is aligned with the first hooking portion 3462, the second hooking portion 3482, or the third hooking portion 3502 in the short side direction D4. This structural configuration makes the stop portion 323 to provide structural constraint to the first hooking portion 3462, the second hooking portion 3482, or the third hooking portion 3502, which is conducive to the holding force of the first hooking portion 3462, the second hooking portion 3482, or the third hooking portion 3502.

Please refer to FIG. 11 to FIG. 13 and FIG. 15. The second support 36 has six holder shafts 372 and eight base shafts 374. The six holder shafts 372 and the eight base shafts 374 are arranged parallel to the pivot axis A3. The six holder shafts 372 are disposed on the long arm 362. Each support arm 364 is provided with two base shafts 374. The second support 36 also has a holder hole 373 formed beside each holder shaft 372. The second support 36 is rotatably connected to the keycap 30 (or the holder hooks 304 thereof) through the holder shafts 372; therein, the holder hooks 304 extends into the corresponding holder holes 373. Furthermore, the second support 36 also has a base hole 375 formed beside each base shaft 374. The second support 36 is slidably and rotatably connected to the base plate 32 (or the base hooks 324 thereof) through the base shafts 374; therein, the base shafts 374 are slidably and rotatably hooked by the corresponding base hook 324, and the base hooks 324 extend into the corresponding base holes 375.

Furthermore, please refer to FIG. 11 and FIG. 13. The keycap 30 has a first long side edge 30a and a second long side edge 30b. The first long side edge 30a and the second long side edge 30b both are parallel to the long side direction D3. In FIG. 13, the vertical direction Dv3 is perpendicular to the paper, so the structural profiles presented in the figure are equivalent to their vertical projections on the paper; furthermore, the profile of the keycap 30 is shown in dashed lines in FIG. 13. In the first embodiment, there is a first distance L3 in the short side direction D4 between a projection of the sliding hole 353 of the first support 34 in the vertical direction Dv3 and a projection of the first long side edge 30a of the keycap 30 in the vertical direction Dv3. There is a second distance L4 in the short side direction D4 between a projection of the holder hole 373 of the second support 36 in the vertical direction Dv3 and a projection of the second long side edge 30b of the keycap 30 in the vertical direction Dv3. The first distance L3 is greater than the second distance L4. This structural configuration provides a larger space for the design of the structural and movement of the sliding shafts 352a of the first support 34. Furthermore, a shaft diameter of the sliding shaft 352a of the first support 34 is greater than a shaft diameter of the holder shaft 372 of the second support 36; this structural configuration helps to increase the rotation and sliding stability of the sliding shafts 352a.

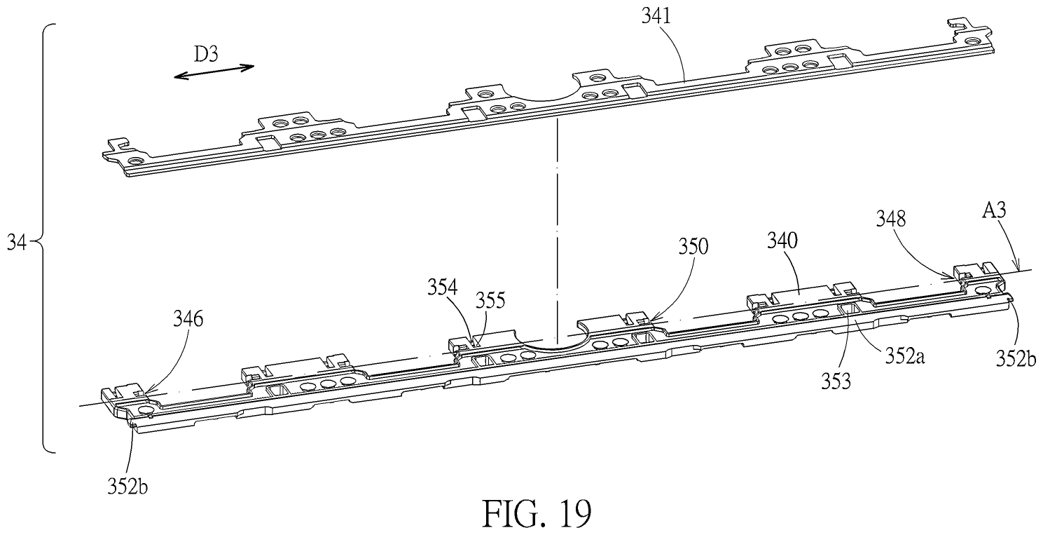

In addition, in the second embodiment, the first support 34 and the second support 36 both have structurally reinforced designs. Please refer to FIG. 14 and FIG. 19; therein, FIG. 19 is an exploded view of the first support 34. The first support 34 includes a support body 340 and a reinforcement part 341. The reinforcement part 341 is embedded into the support body 340. The reinforcement part 341 goes through the sliding shaft 352a and completely surrounds the sliding hole 353. Both structural features can increase the structural strength of the sliding shaft 352a, thereby contributing to the rotation and sliding stability of the sliding shaft 352a. Furthermore, the reinforcement part 341 are provided to also partially surround the first semi-open pivot hole 346 and the second semi-open pivot hole 348 (around three sides of each pivot hole), which helps to increase the structural strength of the first semi-open pivot hole 346 and the second semi-open pivot hole 348, thereby conducive to the stability of the pivot connection between the first support 34 and the second support 36. In addition, the reinforcement part 341 itself also has a plurality of bending structures extending parallel to the pivot axis A3. This structural feature helps to increase the structural strength of the reinforcement part 341 itself, thereby increasing the structural strength of the first support 34.

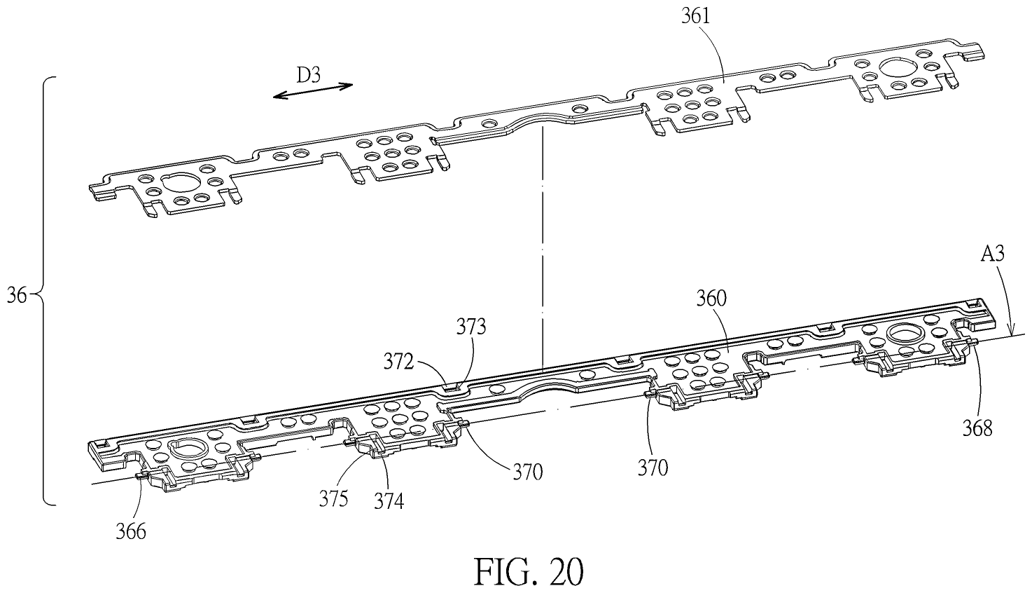

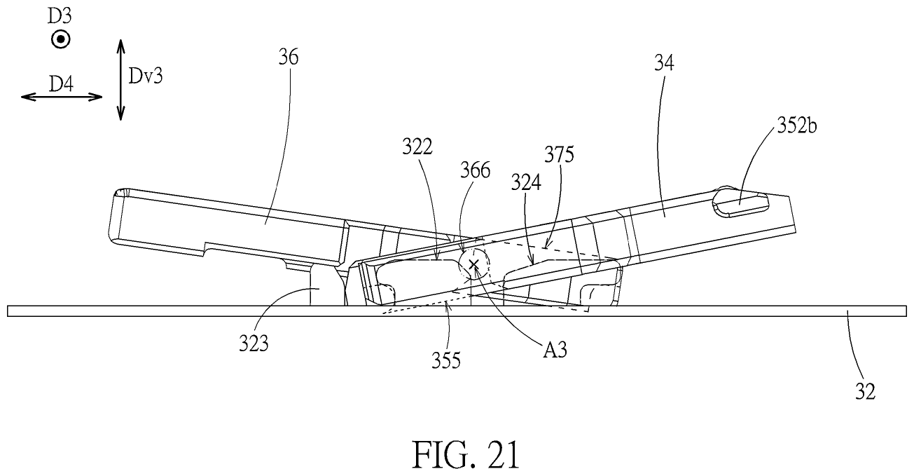

Similarly, please refer to FIG. 15 and FIG. 20; therein, FIG. 20 is an exploded view of the second support 36. The second support 36 includes a support body 360 and a reinforcement part 361. The reinforcement part 361 is embedded into the support body 360 to strengthen the structural strength of the second support 36. Furthermore, the reinforcement part 361 itself also has a plurality of bending structures, which helps to increase the structural strength of the reinforcement part 361 itself, thereby increasing the structural strength of the second support 36. In addition, in practice, the support bodies 340 and 360 may be made of, but are not limited to, plastic, and the reinforcement parts 341 and 361 may be made of, but are not limited to, metal. Furthermore, it is not limited to the fact in practice that both the first support 34 and the second support 36 are structurally reinforced through the reinforcement parts 341 and 361.

In addition, as shown by FIG. 13, in the second embodiment, the first support 34 and the second support 36 jointly form a dome hole 42 (in which the elastic dome 40 is accommodated, as shown by FIG. 11). For the first support 34 and the second support 36, a dome hole coverage range R3 (whose range is marked with chain lines in the figure) is defined in the long side direction D3 with the dome hole 42 as boundaries. The first support 34 and the second support 36 do not have a structure (e.g., like the sliding shaft 352a/the sliding hole 353, the holder shaft 372/the holder hole 373) connected to the keycap 30 and the base plate 32 within the dome hole coverage range R3. This structural design can prevent the structure of the first support 34 and the second support 36 from being weakened by the connection structure.

Furthermore, as shown by FIG. 14, in the first support 34, the dome hole 42 is formed between two of the first support arms 344 (or in other words, the two first support arms 344 form the dome hole 42, and there is no second support arm 364 between the two first support arms 344). A distance 356 from the base hole 355 of the first support arm 344 to the dome hole 42 in the long side direction D3 is greater than or equal to 0.25 times a hole diameter 42a of the dome hole 42 in the long side direction D3. This structural design helps to maintain the structural strength of the support arms adjacent to the dome hole 42 (i.e., the two first support arms 344 mentioned above).

In addition, please refer to FIG. 13 and FIG. 21; therein, FIG. 21 is a left view of the structure shown in FIG. 13, the pivot axis A3 is indicated by a cross mark in the figure, the hidden profile of the first pivot 366 (of the second support 36) is shown in chain lines, the hidden profile of the first blind hole 3464 of the first semi-open pivot hole 346 (of the first support 34) coincides with the hidden profile of the first pivot 366, the hidden profiles of the base hooks 322 and 324 (of the base plate 32) are shown in chain lines, the hidden profile of the base hole 355 (of the first support 34) is shown in dashed lines, and the hidden profile of the base hole 375 (of the second support 36) is also shown in dashed lines. As shown by FIG. 21, a projection of the first pivot 366 in the long side direction D3 (equivalent to the hidden profile of the first pivot 366 in the figure) and a projection of the base hook 322 or the base hole 355 in the long side direction D3 (equivalent to the hidden profile of the base hook 322 or the base hole 355 in the figure) overlap. A projection of the first pivot 366 in the long side direction D3 and a projection of the base hook 324 or the base hole 375 in the long side direction D3 (equivalent to the hidden profile of the base hook 324 or the base hole 375 in the figure) overlap. This structural configuration reduces the distance from the first pivot 366 to the base hooks 322 and 324, i.e., reducing the moment arm from the first pivot 366 to the base hooks 322 and 324, which can reduce the degree of deformation of the first support 34 and the second support 36 during force transmission, thereby increasing the stability of movement of the first support 34 and the second support 36. The same goes for the second semi-open pivot hole 348 and the fully-open pivot hole 350 of the first support 34, the second pivot 368 and the middle pivots 370 of the second support 36, the other base hooks 322 and 324 of the base plate 32, the other base holes 355 of the first support 34, the other base holes 375 of the second support 36, etc., which are not repeated in addition.

Furthermore, as shown by FIG. 13, in the second embodiment, take the connection structures of the first support 34 and the second support 36 shown in the frames in chain lines in the figure as an example, in which the sliding shafts 352a, the sliding holes 353, the fully-open pivot holes 350, the base shafts 354, and the base holes 355 of the first support 34, and the holder shafts 372, the holder holes 373, the middle pivots 370, the base shafts 374, and the base holes 375 of the second support 36 are relatively adjacent to each other. The first support 34 and the second support 36 transmit force and linkage between the first support 34 and the second support 36 and between the keycap 30 and the base plate 32 through the above structures. The relatively close arrangement of the above structures on the pivot axis A3 helps to reduce the torque component of which the direction is perpendicular to the pivot axis A3 when transmitting force, which helps to stabilize the linkage between first support 34 and the second support 36 and between the keycap 30 and the base plate 32, thereby increasing the stability of movement of the first support 34 and second support 36. In the second embodiment, projections of the base holes 355 and the sliding holes 352a of the first support 34 in the vertical direction Dv3 and projections of the holder holes 373 of the second support 36 in the vertical direction Dv3 overlap in the short side direction D4; therein, in FIG. 13, the vertical direction Dv3 is perpendicular to the paper, so the structural profiles presented in the figure are equivalent to their vertical projections on the paper. Furthermore, in the second embodiment, projections of the sliding holes 352a and the fully-open pivot holes 350 of the first support 34 in the vertical direction Dv3 and projections of the holder holes 373 of the second support 36 in the vertical direction Dv3 also overlap in the short side direction D4. Furthermore, in the second embodiment, the first support 34 and the second support 36 also have connection structures relatively close to each other in many places. They also have the above-mentioned projection overlapping characteristics, so they also have corresponding functions, which will not be repeated in addition.

Furthermore, as shown by FIG. 13, for the first support 34 and the second support 36, an arm coverage range R4 (whose range is marked with chain lines in the figure) is defined on the long side direction D3 with two of the first support arms 344 of the first support 34 that are directly adjacent to the dome hole 42 as boundaries (or in other words, the two first support arms 344 form the dome hole 42, and there is no second support arm 364 between the two first support arms 344). The arm coverage range R4 covers the dome hole 42 and several connection structures of the first support 34 and the second support 36. Within the arm coverage range R4, the sum of numbers of the connection structures of the first support 34 (including two sliding shafts 352a/sliding holes 353, two base shafts 354/base holes 355, two fully-open pivot holes 350) and the connection structures of the second support 36 (including two holder shafts 372/holder holes 373, two middle pivots 370) reaches a certain value (such as but not limited to greater than or equal to 8; in the second embodiment, the sum of the numbers is 10), which can increase the structural strength of the first support 34 and the second support 36 here (on the other hand, compensating for the reduction in structural strength of the first support 34 and the second support 36 caused by the existence of the dome hole 42), to improve the transmission effect of first support 34 and second support 36 here (including the transmission along pivot axis A3), thereby increasing the stability of movement of the first support 34 and the second support 36.

In addition, as shown by FIG. 13, the first support arms 344 that are directly adjacent to the dome hole 42 have a width 344a along the long side direction D3 and a length 344b along a direction perpendicular to the long side direction D3. The width 344a is 0.8 to 2 times the length 344b. This structural design helps to maintain the structural strength of the first support arms 344 to a certain extent. Furthermore, the two second support arms 364 that are directly adjacent to the two first support arms 344 have a width 364a along the long side direction D3 and a length 364b along a direction perpendicular to the long side direction D3. The width 364a is 0.8 to 2 times the length 364b. Similarly, this structural design helps to maintain the structural strength of the second support arms 364 to a certain extent. Furthermore, there are two second support arms 364 that are directly adjacent to the two first support arms 344 and are located outside the two first support arms 344 along the pivot axis A3.

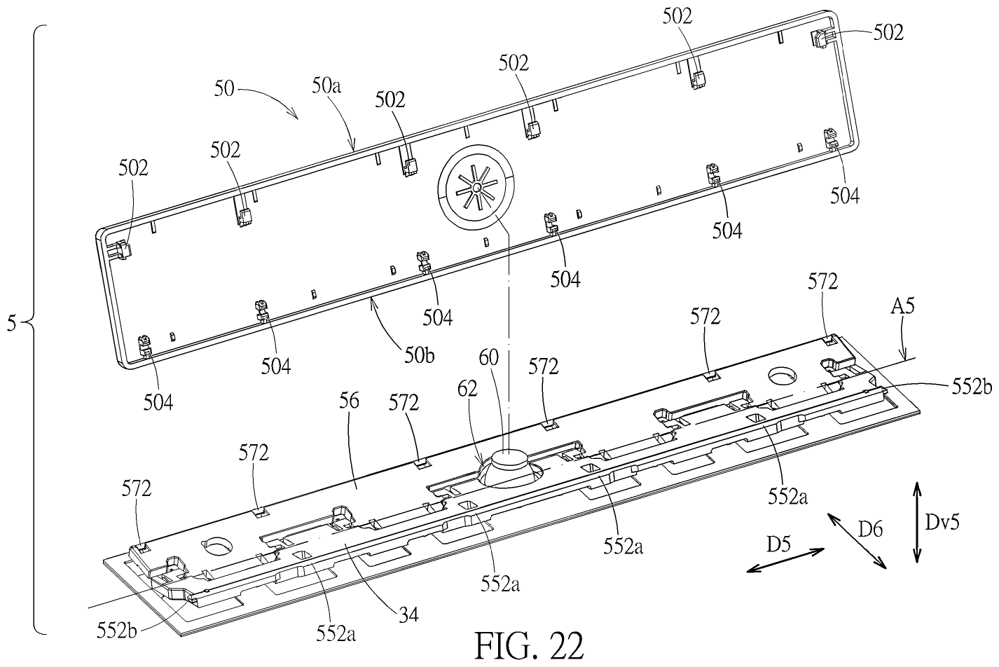

Please refer to FIG. 22 and FIG. 23. A long rectangular keyswitch 5 according to a third embodiment has a long side direction D5 and a short side direction D6 (both are indicated by double-headed arrows in the figures). The long side direction D5 is perpendicular to the short side direction D6. In practice, the long rectangular keyswitch 5 can be but is not limited to a space key. The long rectangular keyswitch 5 includes a keycap 50, a base plate 52, a first support 54, a second support 56, a switch circuit board 58, and an elastic dome 60. The keycap 50 is disposed above the base plate 52. The first support 54 and the second support 56 are pivotally connected around a pivot axis A5 (indicated by a chain line). The pivot axis A5 is parallel to the long side direction D5. The first support 54 and the second support 56 are connected to the keycap 50 and the base plate 52 to support the keycap 50 above the base plate 52, so that the keycap 50 can move (e.g. moving up and down or parallel to a vertical direction Dv5) relative to the base plate 52 through the first support 54 and the second support 56. The vertical direction Dv5 (indicated by a double-headed arrow in the figures) is perpendicular to the long side direction D5 and the short side direction D6. The switch circuit board 58 is placed on the base plate 52. The switch circuit board 58 can be but not limited to a membrane circuit board, and has a switch 582 (shown as a circle filled with oblique lines in the figure), roughly corresponding to the center of the keycap 50. The elastic dome 60 corresponds to the switch 582 and is disposed on switch circuit board 58 and below the keycap 50. The keycap 50 can be pressed to move toward the base plate 52, and then squeezes the elastic dome 60 to trigger the switch 582 downward. Therefore, in logic, the combination of the first support 54 and the second support 56 or the combination of the first support 54, the second support 56, and the base plate 52 can be regarded as a keycap lifting mechanism.

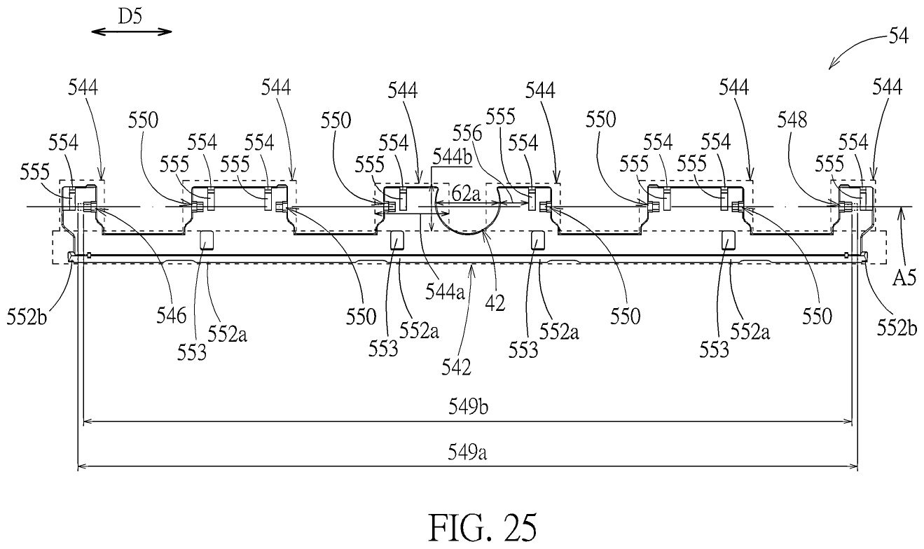

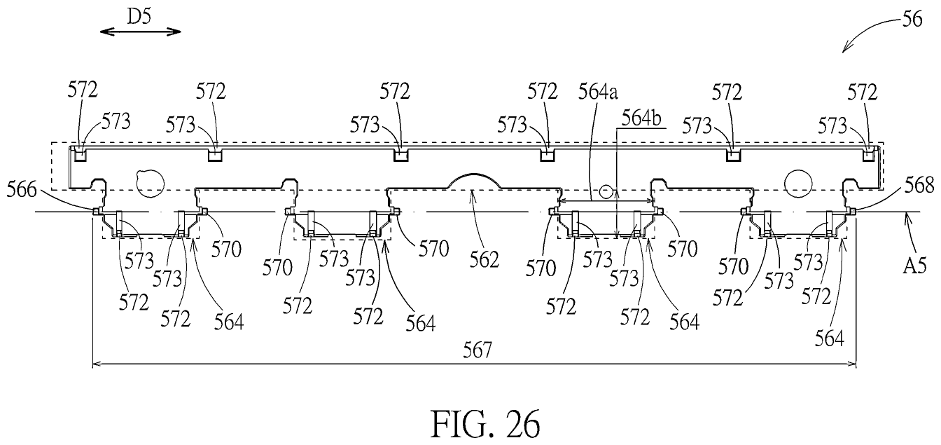

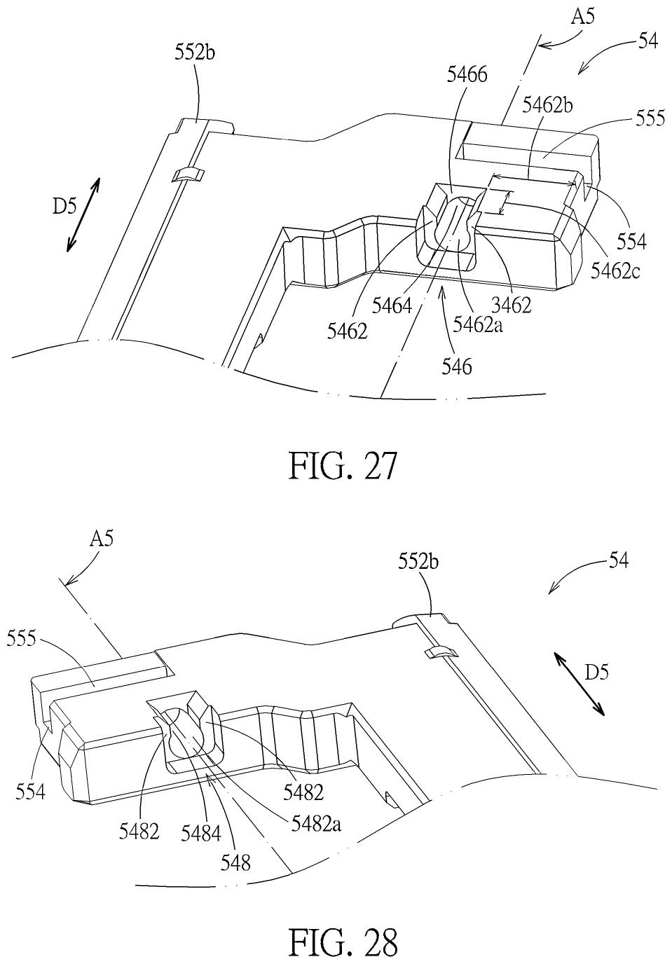

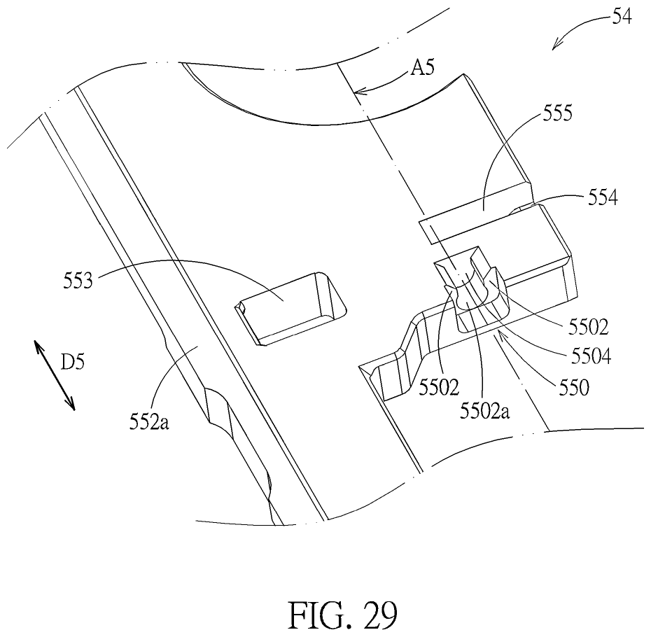

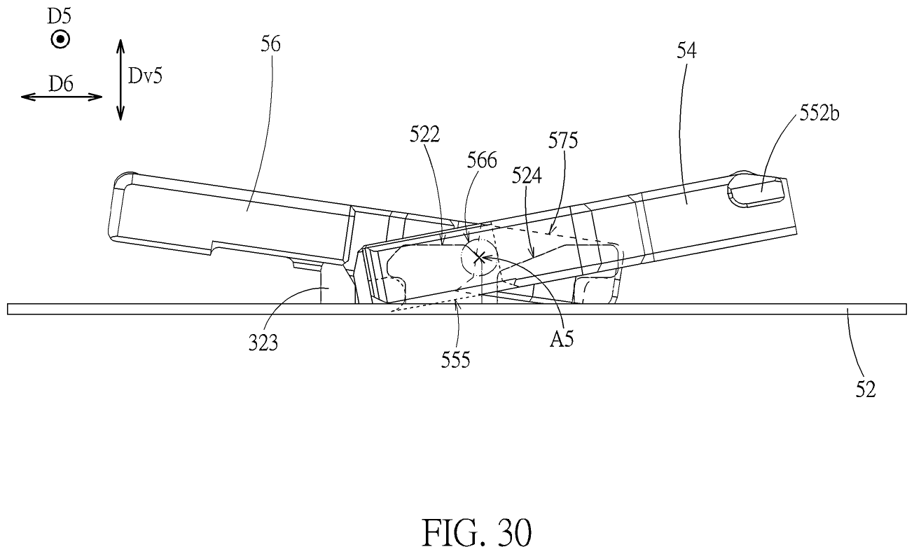

Please also refer to FIG. 24 to FIG. 26; therein, in FIG. 24, the profile of the keycap 50 is shown in dashed lines. The first support 54 includes a first long arm 542 and a plurality of first support arms 544 which protrude from the first long arm 542 in a direction not parallel to the long side direction D3 (in the second embodiment, extending perpendicular to the long side direction D5); the ranges of the first long arm 542 and the support arms 544 are indicated by dashed boxes in FIG. 25. The first support 54 is connected to the keycap 30 through the first long arm 542, and is connected to the base plate 52 through the first support arms 544 (or ends thereof). The second support 56 includes a second long arm 562 and a plurality of second support arms 564 which protrude from the second long arm 562 in a direction not parallel to the long side direction D5 (in the second embodiment, extending perpendicular to the long side direction D5); the ranges of the second long arm 562 and the second support arms 564 are indicated by dashed boxes in FIG. 26. The second support 56 is connected to the keycap 50 through the second long arm 562, and is connected to the base plate 52 through the second support arms 564 (or ends thereof). The first support 54 and the second support 56 are pivotally connected through the plurality of first support arms 544 and the plurality of second support arms 564. The plurality of first support arms 544 and the plurality of second support arms 564 are roughly staggered along the pivot axis A5. Therein, the outermost support arms on the pivot axis A5 are the first support arms 544; at least, one of the first support arms 544 is located between two of the second support arms 564 in the long side direction D5, and one of the second support arms 564 is located between two of the first support arms 544 in the long side direction D5. On the other hand, the first support 54 extends to two opposite outer sides of the second support 56 on the pivot axis A5. In logic, the first support 54 can be regarded as an outer support, and the second support 56 can be regarded as an inner support. Furthermore, all the ends of the first support arms 544 of the first support 54 are connected to the base plate 52. The first support 54 does not have a support arm with a free end (not connected to the base plate 52), so all the first support arms 544 of the first support 54 substantially contribute to the whole structural strength of the first support 54. Similarly, all the ends of the second support arms 564 of the second support 56 are connected to the base plate 52. The second support 56 does not have a support arm with a free end (not connected to the base plate 52), so all the second support arms 564 of the second support 56 substantially contribute to the whole structural strength of the second support 56. This structural configuration can increase the stability of movement of the first support 54 and second support 56.

As shown by FIG. 25, the first support 54 includes a first semi-open pivot hole 546, a second semi-open pivot hole 548, and six fully-open pivot holes 550, which are disposed on the plurality of first support arms 544. The six fully-open pivot holes 550 are arranged between the first semi-open pivot hole 546 and the second semi-open pivot hole 548 on the pivot axis A5. Please also refer to FIG. 27. The first semi-open pivot hole 546 includes two first hooking portions 5462 and a first blind hole 5464, which are adjacently arranged along the pivot axis A5. The two first hooking portions 5462 are arranged opposite to form a first holding space 5462a. The first holding space 5462a communicates with the first blind hole 5464. Please refer to FIG. 25 and FIG. 28. The second semi-open pivot hole 548 includes two second hooking portions 5482 and a second blind hole 5484, which are adjacently arranged along the pivot axis A5. The two second hooking portion 5482 are arranged opposite to form a second holding space 5482a. The second holding space 5482a communicates with the second blind hole 5484. As shown by FIG. 25, the first semi-open pivot hole 546 and the second semi-open pivot hole 548 are structurally symmetrical. Please refer to FIG. 25 and FIG. 29; FIG. 29 is an enlarged view of one of the fully-open pivot holes 550. The fully-open pivot hole 550 includes two third hooking portions 5502. The two third hooking portions 5502 are arranged opposite to form a third holding space 5502a. The structures of the other fully-open pivot holes 550 are also the same, but the orientations may be the same or opposite (which can be determined based on FIG. 25), which will not be described in addition.

In addition, as shown by FIG. 27, a distance 5462b from the front end of the first hooking portion 5462 that is closer to a base plate connection side edge of the first support 54 (i.e. closer to a side edge of the base plate 52) than the other first hooking portion 5462 to the base plate connection side edge in the short side direction D6 is greater than a width 5462c of the first hooking portion 5462 in the long side direction D5. For example, the distance 5462b is 1 to 4 times of the width 5462c, but it is not limited thereto in practice. This structural design helps to maintain the structural strength of the first hooking portion 5462 and the holding force of the two first hooking portions 5462.

As shown by FIG. 26, the second support 56 includes a first pivot 566, a second pivot 568, and six middle pivots 570. The six middle pivots 570 are arranged between the first pivot 566 and the second pivot 568 on the pivot axis A5. Please also refer to FIG. 24. By the first pivot 566, the second pivot 568, and the six middle pivots 570 engaging with the first semi-open pivot hole 546, the second semi-open pivot hole 548, and the six fully-open pivot holes 550 respectively, the first support 54 and the second support 56 are pivotally connected around the pivot axis A5. Therein, as shown by FIG. 24, the first pivot 566 is held by the two first hooking portions 5462 in the first holding space 5462a and extends into the first blind hole 5464. The second pivot 568 is held by the two second hooking portions 5482 in the second holding space 5482a and extends into the second blind hole 5484. The middle pivot 570 is held by the two third hooking portions 5502 in the third holding space 5502a. Therein, in the first semi-open pivot hole 546, the first pivot 566 is structurally constrained by the two first hooking portions 5462 and the first blind hole 5464 at the same time; the same goes for the second semi-open pivot hole 548 and the second pivot 568. In the fully-open pivot hole 550, the middle pivot 570 is mainly structurally constrained by the two third hooking portions 5502. Therefore, in principle, the connection strength between the first semi-open pivot hole 546 and the first pivot 566 (or between the second semi-open pivot hole 548 and the second pivot 568) is greater than the connection strength between the fully-open pivot hole 550 and the middle pivot 570.

Please refer to FIG. 24 to FIG. 26. In the first support 54, there is a distance 549a between the bottom of the first blind hole 5464 (of the first semi-open pivot hole 546) and the bottom of the second blind hole 5484 (of the second semi-open pivot hole 548) along the pivot axis A5. There is a distance 549b between the opening of the first blind hole 5464 and the opening of the second blind hole 5484 along the pivot axis A5. Therein, the hidden profiles of the first blind hole 5464 and the second blind hole 5484 in FIG. 25 are shown in dashed lines. In the second support 56, there is a distance 567 between the end of the first pivot 566 and the end of the second pivot 568 along pivot axis A5. The distance 567 is greater than the distance 549b and less than the distance 549a. In an actual assembly of the first support 54 and the second support 56, force can be applied to the second support 56 first to make it slightly arched, so that the linear distance between the first pivot 366 and the second pivot 568 is reduced to be less than the linear distance between the first semi-open pivot hole 546 and the second semi-open pivot hole 548. Then, keep the second support 56 arched and snap the first pivot 366 and second pivot 568 of the second support 56 into the first semi-open pivot hole 546 and the second semi-open pivot hole 548; then, release the second support 56. At this time, the middle pivots 570 will contact the corresponding fully-open pivot holes 550 in principle. Then, press the second support 56 toward the first support 54 to make the middle pivots 570 snap into the fully-open pivot holes 550. Finally, the first semi-open pivot hole 546, the second semi-open pivot hole 548, and the fully-open pivot hole 550 are completely engaged to the first pivot 566, the second pivot 568, and the middle pivot 570 respectively. In addition, in the connection structure of the first support 54 and the second support 56, the first semi-open pivot hole 546 and the second semi-open pivot hole 548 are located at the outermost side of the first support 34 along the pivot axis A5, so in the process of assembling the first support 54 and the second support 56, the second support 56 can make the first pivot 566 and the second pivot 568 to connect with the first semi-open pivot hole 546 and the second semi-open pivot hole 548 with a small degree of deformation. In other words, this connection structure design can take into account the ease of assembly of the first support 54 and the second support 56 and the overall connection strength between the first support 54 and the second support 56. Furthermore, that the first semi-open pivot hole 546 and the second semi-open pivot hole 548 are located at the outermost side along the pivot axis A5 also helps to maintain the stability of the pivot connection between the first support 54 and the second support 56.

In addition, as shown by FIG. 27 to FIG. 29, in the third embodiment, the two first hooking portions 5462, the two second hooking portions 5482, or the two third hooking portions 5502 have, along the pivot axis A5, an open structure on one side and a side wall on the other side (therein, the side wall extends perpendicular to the pivot axis A5 and connects the two hooking portions; e.g., the side wall 5466 in FIG. 27, the side wall 5486 in FIG. 28, and the side wall 5504 in FIG. 29). This structural design helps to increase the structural strength of the hooking portions themselves and the holding strength of the hooking portions. However, it is not limited thereto in practice. For example, it is practicable to modify the structures of the two first hooking portions 5462, the second hooking portions 5482, or the two third hooking portions 5502 so that their structures are open on both sides along the pivot axis A5 (that is, there is no side wall to connect them); this structural design can increasing its structural flexibility, which is conducive to the assembly of the first pivot 566, the second pivot 568, and the middle pivots 570.

Please refer to FIG. 22 to FIG. 25. The first support 54 has six sliding shafts 552a and 552b and eight base shafts 554. The six sliding shafts 552a and 552b are arranged parallel to the pivot axis A5 on the first long arm 542; therein, the four sliding shafts 552a are located between the two sliding shafts 552b. The sliding shaft 552b is achieved by a protruding post extending parallel to the pivot axis A5. The first support 54 also has a sliding hole 553 formed beside each sliding shaft 552a. The first support 54 is slidably and rotatably connected to the keycap 50 (or the sliding hooks 502 thereof) through the sliding shafts 552a and 552b; therein, the sliding hooks 502 extend into the corresponding sliding holes 553. Furthermore, the eight base shafts 554 are arranged parallel to the pivot axis A5 on the plurality of first support arms 544. The first support 54 also has a base hole 555 formed beside each base shaft 554. The first support 54 is rotatably connected to the base plate 52 (or the base hooks 522 thereof) through the base shafts 554; therein, the base shafts 554 are rotatably hooked by the corresponding base hooks 522, and the base hooks 522 extend into the corresponding base holes 555. Furthermore, the base plate 52 also includes a plurality of stop portions 523. The stop portions 523 limit the first support 54 so that the base shafts 554 remain hooked by the corresponding base hooks 522. In addition, in the third embodiment, the stop portion 523 is aligned with the first hooking portion 5462, the second hooking portion 5482, or the third hooking portion 5502 in the short side direction D6. This structural configuration makes the stop portion 523 to provide structural constraint to the first hooking portion 5462, the second hooking portion 5482, or the third hooking portion 5502, which is conducive to the holding force of the first hooking portion 5462, the second hooking portion 5482, or the third hooking portion 5502.

Please refer to FIG. 22 to FIG. 24 and FIG. 26. The second support 56 has six holder shafts 572 and eight base shafts 574. The six holder shafts 572 and the eight base shafts 574 are arranged parallel to the pivot axis A5. The six holder shafts 572 are disposed on the long arm 562. Each support arm 564 is provided with two base shafts 574. The second support 56 also has a holder hole 573 formed beside each holder shaft 572. The second support 56 is rotatably connected to the keycap 50 (or the holder hooks 504 thereof) through the holder shafts 572; therein, the holder hooks 504 extends into the corresponding holder holes 573. Furthermore, the second support 56 also has a base hole 575 formed beside each base shaft 574. The second support 56 is slidably and rotatably connected to the base plate 52 (or the base hooks 524 thereof) through the base shafts 574; therein, the base shafts 574 are slidably and rotatably hooked by the corresponding base hook 524, and the base hooks 524 extend into the corresponding base holes 575.

Furthermore, please refer to FIG. 22 and FIG. 24. The keycap 50 has a first long side edge 50a and a second long side edge 50b. The first long side edge 50a and the second long side edge 50b both are parallel to the long side direction D5. In FIG. 24, the vertical direction Dv5 is perpendicular to the paper, so the structural profiles presented in the figure are equivalent to their vertical projections on the paper; furthermore, the profile of the keycap 50 is shown in dashed lines in FIG. 24. In the third embodiment, there is a first distance L5 in the short side direction D6 between a projection of the sliding hole 553 of the first support 54 in the vertical direction Dv5 and a projection of the first long side edge 50a of the keycap 50 in the vertical direction Dv5. There is a second distance L6 in the short side direction D6 between a projection of the holder hole 573 of the second support 56 in the vertical direction Dv5 and a projection of the second long side edge 50b of the keycap 50 in the vertical direction Dv5. The first distance L5 is greater than the second distance L6. This structural configuration provides a larger space for the design of the structural and movement of the sliding shafts 552a of the first support 54. Furthermore, a shaft diameter of the sliding shaft 552a of the first support 54 is greater than a shaft diameter of the holder shaft 572 of the second support 56; this structural configuration helps to increase the rotation and sliding stability of the sliding shafts 552a.

In addition, as shown by FIG. 24, in the third embodiment, the first support 54 and the second support 56 jointly form a dome hole 62 (in which the elastic dome 60 is accommodated, as shown by FIG. 22). For the first support 54 and the second support 56, a dome hole coverage range R5 (whose range is marked with chain lines in the figure) is defined in the long side direction D5 with the dome hole 62 as boundaries. The first support 54 and the second support 56 do not have a structure (e.g., like the sliding shaft 552a/the sliding hole 553, the holder shaft 572/the holder hole 573) connected to the keycap 50 and the base plate 52 within the dome hole coverage range R5. This structural design can prevent the structure of the first support 54 and the second support 56 from being weakened by the connection structure.

Furthermore, as shown by FIG. 25, in the first support 54, the dome hole 62 is formed between two of the first support arms 544 (or in other words, the two first support arms 544 form the dome hole 62, and there is no second support arm 564 between the two first support arms 544). A distance 556 from the base hole 555 of the first support arm 544 to the dome hole 62 in the long side direction D5 is greater than or equal to 0.25 times a hole diameter 62a of the dome hole 62 in the long side direction D5. This structural design helps to maintain the structural strength of the support arms adjacent to the dome hole 62 (i.e., the two first support arms 544 mentioned above).

In addition, please refer to FIG. 24 and FIG. 30; therein, FIG. 30 is a left view of the structure shown in FIG. 24, the pivot axis A5 is indicated by a cross mark in the figure, the hidden profile of the first pivot 566 (of the second support 56) is shown in chain lines, the hidden profile of the first blind hole 5464 of the first semi-open pivot hole 546 (of the first support 54) coincides with the hidden profile of the first pivot 566, the hidden profiles of the base hooks 522 and 524 (of the base plate 52) are shown in chain lines, the hidden profile of the base hole 555 (of the first support 54) is shown in dashed lines, and the hidden profile of the base hole 575 (of the second support 56) is also shown in dashed lines. As shown by FIG. 30, a projection of the first pivot 566 in the long side direction D5 (equivalent to the hidden profile of the first pivot 566 in the figure) and a projection of the base hook 522 or the base hole 555 in the long side direction D5 (equivalent to the hidden profile of the base hook 522 or the base hole 555 in the figure) overlap. A projection of the first pivot 566 in the long side direction D5 and a projection of the base hook 524 or the base hole 575 in the long side direction D5 (equivalent to the hidden profile of the base hook 524 or the base hole 575 in the figure) overlap. This structural configuration reduces the distance from the first pivot 566 to the base hooks 522 and 524, i.e., reducing the moment arm from the first pivot 566 to the base hooks 522 and 524, which can reduce the degree of deformation of the first support 54 and the second support 56 during force transmission, thereby increasing the stability of movement of the first support 54 and the second support 56. The same goes for the second semi-open pivot hole 548 and the fully-open pivot hole 550 of the first support 54, the second pivot 568 and the middle pivots 570 of the second support 56, the other base hooks 522 and 524 of the base plate 52, the other base holes 555 of the first support 54, the other base holes 575 of the second support 56, etc., which are not repeated in addition.

Furthermore, as shown by FIG. 24, in the third embodiment, take the connection structures of the first support 54 and the second support 56 shown in the frames in chain lines in the figure as an example, in which the sliding shafts 552a, the sliding holes 553, the fully-open pivot holes 550, the base shafts 554, and the base holes 555 of the first support 54, and the holder shafts 572, the holder holes 573, the middle pivots 570, the base shafts 574, and the base holes 575 of the second support 56 are relatively adjacent to each other. The first support 54 and the second support 56 transmit force and linkage between the first support 54 and the second support 56 and between the keycap 50 and the base plate 52 through the above structures. The relatively close arrangement of the above structures on the pivot axis A5 helps to reduce the torque component of which the direction is perpendicular to the pivot axis A5 when transmitting force, which helps to stabilize the linkage between first support 54 and the second support 56 and between the keycap 50 and the base plate 52, thereby increasing the stability of movement of the first support 54 and second support 56. In the third embodiment, projections of the base holes 555 and the sliding holes 552a of the first support 54 in the vertical direction Dv5 and projections of the holder holes 573 of the second support 56 in the vertical direction Dv5 overlap in the short side direction D6; therein, in FIG. 24, the vertical direction Dv5 is perpendicular to the paper, so the structural profiles presented in the figure are equivalent to their vertical projections on the paper. Furthermore, in the third embodiment, projections of the sliding holes 552a and the fully-open pivot holes 550 of the first support 54 in the vertical direction Dv5 and projections of the holder holes 573 of the second support 56 in the vertical direction Dv5 also overlap in the short side direction D6. Furthermore, in the third embodiment, the first support 54 and the second support 56 also have connection structures relatively close to each other in many places. They also have the above-mentioned projection overlapping characteristics, so they also have corresponding functions, which will not be repeated in addition.

Furthermore, as shown by FIG. 24, for the first support 54 and the second support 56, an arm coverage range R6 (whose range is marked with chain lines in the figure) is defined on the long side direction D5 with two of the first support arms 544 of the first support 54 that are directly adjacent to the dome hole 62 as boundaries (or in other words, the two first support arms 544 form the dome hole 62, and there is no second support arm 564 between the two first support arms 544). The arm coverage range R6 covers the dome hole 62 and several connection structures of the first support 54 and the second support 56. Within the arm coverage range R6, the sum of numbers of the connection structures of the first support 54 (including two sliding shafts 552a/sliding holes 553, two base shafts 554/base holes 555, two fully-open pivot holes 550) and the connection structures of the second support 56 (including two holder shafts 572/holder holes 573, two middle pivots 570) reaches a certain value (such as but not limited to greater than or equal to 8; in the third embodiment, the sum of the numbers is 10), which can increase the structural strength of the first support 54 and the second support 56 here (on the other hand, compensating for the reduction in structural strength of the first support 54 and the second support 56 caused by the existence of the dome hole 62), to improve the transmission effect of first support 54 and second support 56 here (including the transmission along pivot axis A5), thereby increasing the stability of movement of the first support 54 and the second support 56.

In addition, as shown by FIG. 24, the first support arms 544 that are directly adjacent to the dome hole 62 have a width 544a along the long side direction D5 and a length 544b along a direction perpendicular to the long side direction D5. The width 544a is 0.8 to 2 times the length 544b. This structural design helps to maintain the structural strength of the first support arms 544 to a certain extent. Furthermore, the two second support arms 564 that are directly adjacent to the two first support arms 544 have a width 564a along the long side direction D5 and a length 564b along a direction perpendicular to the long side direction D5. The width 564a is 0.8 to 2 times the length 564b. Similarly, this structural design helps to maintain the structural strength of the second support arms 564 to a certain extent. Furthermore, there are two second support arms 564 that are directly adjacent to the two first support arms 544 and are located outside the two first support arms 544 along the pivot axis A5.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A keycap lifting mechanism, used for a long rectangular keyswitch, the long rectangular keyswitch having a long side direction and a short side direction, the keycap lifting mechanism comprising:
a base plate, the base plate comprising a first base hook and a second base hook;
a first support, the first support comprising a pivot hole, a first base shaft, and a first base hole formed beside the first base shaft, the first base shaft being rotatably hooked by the first base hook, the first base hook extending into the first base hole; and
a second support, the second support comprising a pivot, a second base shaft, and a second base hole beside the second base shaft, the second base shaft being rotatably hooked by the second base hook, the second base hook extending into the second base hole, the pivot being inserted into the pivot hole so that the first support and the second support rotate relative to each other about a pivot axis, the pivot axis being parallel to the long side direction;
wherein a projection of the pivot in the long side direction overlaps a projection of the first base hook or the first base hole in the long side direction, and the projection of the pivot in the long side direction overlaps a projection of the second base hook or the second base hole in the long side direction.

2. The keycap lifting mechanism according to claim 1, wherein the first support comprises a support body and a reinforcement part, the reinforcement part is embedded into the support body, the first support has a sliding shaft and a sliding hole formed beside the sliding shaft, the reinforcement part goes through the sliding shaft, and the first support is slidably and rotatably connected to a keycap of the long rectangular keyswitch through the sliding shaft.

3. The keycap lifting mechanism according to claim 1, wherein the first support has a sliding shaft and a sliding hole formed beside the sliding shaft, the second support has a holder shaft and a holder hole formed beside the holder shaft, a shaft diameter of the sliding shaft is greater than a shaft diameter of the holder shaft, the first support is slidably and rotatably connected to a keycap of the long rectangular keyswitch through the sliding shaft, and the second support is rotatably connected to the keycap of the long rectangular keyswitch through the holder shaft.

4. A keycap lifting mechanism, used for a long rectangular keyswitch, the long rectangular keyswitch having a long side direction and a short side direction, the keycap lifting mechanism comprising:
a base plate;
a first support, the first support comprising a first long arm and a plurality of first support arms, the first long arm extending parallel to the long side direction, the plurality of first support arms protruding from the first long arm in a direction not parallel to the long side direction and being connected to the base plate; and
a second support, the second support comprising a second long arm and a plurality of second support arms, the second long arm extending parallel to the long side direction, the plurality of second support arms protruding from the second long arm in a direction not parallel to the long side direction and being connected to the base plate;
wherein the first support and the second support are pivotally connected around a pivot axis, one of the plurality of first support arms is located between two of the plurality of second support arms in the long side direction, and one of the plurality of second support arms is located between two of the plurality of first support arms in the long side direction.

5. The keycap lifting mechanism according to claim 4, wherein the first support comprises a support body and a reinforcement part, the reinforcement part is embedded into the support body, the first support has a sliding shaft and a sliding hole formed beside the sliding shaft, the reinforcement part goes through the sliding shaft, and the first support is slidably and rotatably connected to a keycap of the long rectangular keyswitch through the sliding shaft.

6. The keycap lifting mechanism according to claim 4, wherein the first support has a sliding shaft and a sliding hole formed beside the sliding shaft, the second support has a holder shaft and a holder hole formed beside the holder shaft, a shaft diameter of the sliding shaft is larger than a shaft diameter of the holder shaft, the first support is slidably and rotatably connected to a keycap of the long rectangular keyswitch through the sliding shaft, and the second support is rotatably connected to the keycap of the long rectangular keyswitch through the holder shaft.

7. The keycap lifting mechanism according to claim 4, wherein two of the plurality of first support arms form a dome hole between them, the base plate comprises two base hooks, each of the two first support arms comprises a base shaft and a base hole formed beside the base shaft, the two base shaft are rotatably hooked by the two base hooks respectively, the two base hooks extend into the two base holes respectively, and a distance from the base hole to the dome hole in the long side direction is greater than or equals to 0.25 times a hole diameter of the dome hole in the long side direction.

8. A keycap lifting mechanism, used for a long rectangular keyswitch, the long rectangular keyswitch having a long side direction and a short side direction, the keycap lifting mechanism comprising:
a first support, the first support comprising a first semi-open pivot hole, a second semi-open pivot hole, and a fully-open pivot hole, the fully-open pivot hole being located between the first semi-open pivot hole and the second semi-open pivot hole in the long side direction, the first semi-open pivot hole comprising two first hooking portions and a first blind hole, the two first hooking portions being disposed oppositely to form a first holding space, the first blind hole communicating with the first holding space, the second semi-open pivot hole comprising two second hooking portions and a second blind hole, the two second hooking portions being disposed oppositely to form a second holding space, the second blind hole communicating with the second holding space, an opening of the first blind hole being opposite to an opening of the second blind hole, the fully-open pivot hole comprising two third hooking portions, the two third hooking portions being disposed oppositely to form a third holding space; and
a second support, the second support comprising a first pivot, a second pivot, and a middle pivot, the first pivot being held by the two first hooking portions in the first holding space and extending into the first blind hole, the second pivot being held by the two second hooking portions in the second holding space and extending into the second blind hole, the middle pivot being held by the two third hooking portions in the third holding space, so that the first support and the second support are pivotally connected around a pivot axis, the pivot axis being parallel to the long side direction.

9. The keycap lifting mechanism according to claim 8, wherein a distance from a front end of the first hooking portion that is closer to a base plate connection side edge of the first support to the base plate connection side edge in the short side direction is 1 to 4 times a width of said first hooking portion in the long side direction.

10. The keycap lifting mechanism according to claim 8, wherein the first support is located on two opposite sides of the second support on the pivot axis.

11. The keycap lifting mechanism according to claim 8, wherein the fully-open pivot hole comprises a side wall, the two third hooking portions are located on a side of the side wall in the long side direction, and the side wall connects the two third hooking portions.

12. The keycap lifting mechanism according to claim 8, wherein the first support comprises a support body and a reinforcement part, the reinforcement part is embedded into the support body, the first support has a sliding shaft and a sliding hole formed beside the sliding shaft, the reinforcement part goes through the sliding shaft, and the first support is slidably and rotatably connected to a keycap of the long rectangular keyswitch through the sliding shaft.

13. The keycap lifting mechanism according to claim 12, wherein the reinforcement part surrounds the sliding hole.

14. The keycap lifting mechanism according to claim 8, whereinthe first support has a sliding shaft and a sliding hole formed beside the sliding shaft, the second support has a holder shaft and a holder hole formed beside the holder shaft, a shaft diameter of the sliding shaft is greater than a shaft diameter of the holder shaft, the first support is slidably and rotatably connected to a keycap of the long rectangular keyswitch through the sliding shaft, and the second support is rotatably connected to the keycap of the long rectangular keyswitch through the holder shaft.

15. A long rectangular keyswitch, the long rectangular keyswitch having a long side direction and a short side direction, the long rectangular keyswitch comprising:
a keycap, the keycap having a first long side edge and a second long side edge, the first long side edge and the second long side edge being parallel to the long side direction; and
a keycap lifting mechanism, comprising:
a base plate, the base plate comprising a first base hook and a second base hook;
a first support, the first support comprising a pivot hole, a first base shaft, and a first base hole formed beside the first base shaft, the first base shaft being rotatably hooked by the first base hook, the first base hook extending into the first base hole; and
a second support, the second support comprising a pivot, a second base shaft, and a second base hole beside the second base shaft, the second base shaft being rotatably hooked by the second base hook, the second base hook extending into the second base hole, the pivot being inserted into the pivot hole so that the first support and the second support rotate relative to each other about a pivot axis, the pivot axis being parallel to the long side direction;
wherein the keycap is supported by the first support and the second support to move up and down parallel to a vertical direction, the first support has a sliding shaft and a sliding hole formed beside the sliding shaft, the second support has a holder shaft and a holder hole formed beside the holder shaft, the first support is slidably and rotatably connected to the keycap through the sliding shaft, the second support is rotatably connected to the keycap through the holder shaft, there is a first distance in the short side direction between a projection of the sliding hole in the vertical direction and a projection of the first long side edge in the vertical direction, there is a second distance in the short side direction between a projection of the holder hole in the vertical direction and a projection of the second long side edge in the vertical direction, and the first distance is greater than the second distance;
wherein a projection of the pivot in the long side direction overlaps a projection of the first base hook or the first base hole in the long side direction, and the projection of the pivot in the long side direction overlaps a projection of the second base hook or the second base hole in the long side direction.

16. A long rectangular keyswitch, the long rectangular keyswitch having a long side direction and a short side direction, the long rectangular keyswitch comprising:
a keycap, the keycap having a first long side edge and a second long side edge, the first long side edge and the second long side edge being parallel to the long side direction; and
a keycap lifting mechanism, comprising:
a base plate;
a first support, the first support comprising a first long arm and a plurality of first support arms, the first long arm extending parallel to the long side direction, the plurality of first support arms protruding from the first long arm in a direction not parallel to the long side direction and being connected to the base plate; and
a second support, the second support comprising a second long arm and a plurality of second support arms, the second long arm extending parallel to the long side direction, the plurality of second support arms protruding from the second long arm in a direction not parallel to the long side direction and being connected to the base plate;
wherein the keycap is supported by the first support and the second support to move up and down parallel to a vertical direction, the first support has a sliding shaft and a sliding hole formed beside the sliding shaft, the second support has a holder shaft and a holder hole formed beside the holder shaft, the first support is slidably and rotatably connected to the keycap through the sliding shaft, the second support is rotatably connected to the keycap through the holder shaft, there is a first distance in the short side direction between a projection of the sliding hole in the vertical direction and a projection of the first long side edge in the vertical direction, there is a second distance in the short side direction between a projection of the holder hole in the vertical direction and a projection of the second long side edge in the vertical direction, and the first distance is greater than the second distance;
wherein the first support and the second support are pivotally connected around a pivot axis, one of the plurality of first support arms is located between two of the plurality of second support arms in the long side direction, and one of the plurality of second support arms is located between two of the plurality of first support arms in the long side direction.

17. A long rectangular keyswitch, the long rectangular keyswitch having a long side direction and a short side direction, the long rectangular keyswitch comprising:
a keycap, the keycap having a first long side edge and a second long side edge, the first long side edge and the second long side edge being parallel to the long side direction; and
a keycap lifting mechanism, comprising:
a first support, the first support comprising a first semi-open pivot hole, a second semi-open pivot hole, and a fully-open pivot hole, the fully-open pivot hole being located between the first semi-open pivot hole and the second semi-open pivot hole in the long side direction, the first semi-open pivot hole comprising two first hooking portions and a first blind hole, the two first hooking portions being disposed oppositely to form a first holding space, the first blind hole communicating with the first holding space, the second semi-open pivot hole comprising two second hooking portions and a second blind hole, the two second hooking portions being disposed oppositely to form a second holding space, the second blind hole communicating with the second holding space, an opening of the first blind hole being opposite to an opening of the second blind hole, the fully-open pivot hole comprising two third hooking portions, the two third hooking portions being disposed oppositely to form a third holding space; and
a second support, the second support comprising a first pivot, a second pivot, and a middle pivot, the first pivot being held by the two first hooking portions in the first holding space and extending into the first blind hole, the second pivot being held by the two second hooking portions in the second holding space and extending into the second blind hole, the middle pivot being held by the two third hooking portions in the third holding space, so that the first support and the second support are pivotally connected around a pivot axis, the pivot axis being parallel to the long side direction;
wherein the keycap is supported by the first support and the second support to move up and down parallel to a vertical direction, the first support has a sliding shaft and a sliding hole formed beside the sliding shaft, the second support has a holder shaft and a holder hole formed beside the holder shaft, the first support is slidably and rotatably connected to the keycap through the sliding shaft, the second support is rotatably connected to the keycap through the holder shaft, there is a first distance in the short side direction between a projection of the sliding hole in the vertical direction and a projection of the first long side edge in the vertical direction, there is a second distance in the short side direction between a projection of the holder hole in the vertical direction and a projection of the second long side edge in the vertical direction, and the first distance is greater than the second distance.
